(19) United States
(12) Patent Application Publication
(10) Pub. No.: US 2013/0175972 A1
(43) Pub. Date: Jul. 11, 2013

(54) FUEL CELL SYSTEM AND METHOD FOR CONTROLLING THE SAME

(71) Applicant: Takashi Akiyama, Osaka (JP)

(72) Inventor: Takashi Akiyama, Osaka (JP)

(73) Assignee: PANASONIC CORPORATION, Osaka (JP)

(21) Appl. No.: 13/809,865

(22) PCT Filed: Apr. 6, 2012
(86) PCT No.: PCT/JP12/02449

§ 371 Date: Jan. 11, 2013

(30) Foreign Application Priority Data
Jul. 14, 2011 (JP) 2011-155327

(51) Int. Cl. H02J 7/00

(52) U.S. Cl. CPC H02J 7/00
USPC 320/101

(57) ABSTRACT

Disclosed is a method for controlling a fuel cell system including a fuel cell and a secondary battery, to variably control an output power of the fuel cell. The method includes the steps of: (i) charging the secondary battery with the output power or discharging the secondary battery, depending on an amount of power supplied to a load and the output power; (ii) detecting a remaining capacity CR of the secondary battery; (iii) switching stepwise the output power, depending on the remaining capacity CR; (iv) detecting the number of cycles of the charging and discharging of the secondary battery; and (v) correcting conditions for switching the output power, on the basis of the detected number of cycles of the charging and discharging.

### TECHNICAL FIELD

The present invention relates to a fuel cell system including a secondary battery and a fuel cell such as a direct oxidation fuel cell, and specifically relates to a hybrid control of the fuel cell system in which the operating state of the fuel cell is switched on the basis of the remaining capacity of the secondary battery.

### BACKGROUND ART

Fuel cells are classified according to the type of electrolyte used therein into polymer electrolyte fuel cells, phosphoric acid fuel cells, alkaline fuel cells, molten carbonate fuel cells, and solid oxide fuel cells, etc. Among them, polymer electrolyte fuel cells (PEFCs) operate at low temperatures and have a high output density, and therefore, are being put into practical use as a vehicle-mounted power source, a power source for household cogeneration systems, and the like.

In recent years, studies have been made for using fuel cells as a power source for portable small-size electronic equipment such as notebook personal computers, cellular phones, and personal digital assistants (PDAs). Fuel cells can continuously generate power as long as there is uninterrupted supply of fuel. Therefore, using fuel cells as a replacement of secondary batteries which need recharging is expected to further improve the convenience of portable small-size electronic equipment. The aforementioned PEFCs, because of their low operating temperatures, are advantageous as a power source for portable small-size electronic equipment. Studies are also been made for putting fuel cells into practical use as a power source for outdoor activities such as camping.

Among PEFCs, direct oxidation fuel cells (DOFCs) use a fuel which is liquid at room temperature, and outputs electric energy by directly oxidizing the fuel without reforming it into hydrogen. As such, direct oxidation fuel cells require no reformer, and are easy to be miniaturized in size. Most promising direct oxidation fuel cells that can be used as a power source for portable small-size electronic equipment are direct methanol fuel cells (DMFCs) which use methanol as a fuel, because they are more excellent in energy efficiency and power generation output than the other direct oxidation fuel cells.

The reactions at the anode and cathode in DMFCs are shown below as the reaction formulae (11) and (12). Oxygen to be introduced into the cathode is generally supplied from the air.

Anode: CH₃OH+H₂O→CO₂+6H⁺+6e⁻ (11)

Cathode: (3/2)O₂+6H⁺+6e⁻→3H₂O (12)

Polymer electrolyte fuel cells such as DMFCs generally include a cell stack formed by stacking a plurality of cells. Each cell includes a polymer electrolyte membrane, and an anode and a cathode sandwiching the polymer electrolyte membrane. The anode and cathode each include a catalyst layer and a diffusion layer. For example, to the anode of DMFC, methanol is supplied as a fuel, and to the cathode, air is supplied as an oxidant.

The fuel flow channel for supplying fuel to the anode is formed, for example, as a meandering groove on the surface contacting the anode of the anode-side separator disposed in contact with the anode diffusion layer. Likewise, the air flow channel for supplying air to the cathode is formed, for example, as a meandering groove on the surface contacting the cathode of the cathode-side separator disposed in contact with the cathode diffusion layer.

Currently, a technical challenge to be achieved in direct oxidation fuel cells such as DMFCs is suppression of a phenomenon in which fuel (e.g., methanol) supplied to the anode permeates through the polymer electrolyte membrane and reaches the cathode where the fuel is oxidized. This phenomenon is called methanol crossover (MCO), which can be a cause of a decreased fuel utilization efficiency. Furthermore, the oxidation reaction of fuel that occurs at the cathode in association with MCO, competing with the reduction reaction of oxidant (oxygen) that normally occurs at the cathode, lowers the electrical potential at the cathode. Therefore, MCO can also be a cause of a lower generated voltage and a decreased power generation efficiency.

A fuel cell must be externally supplied with a reaction material. Therefore, for an application where the load thereof fluctuates rapidly, a fuel cell is generally used in combination with a secondary battery or capacitor, forming a hybrid system. The secondary battery to be used as the power storage device is preferably a secondary battery with high energy density, such as a nickel-cadmium secondary battery, nickel-metal hydride secondary battery, and lithium ion secondary battery. Among them, a lithium ion secondary battery, which has the highest energy density and is excellent in long term storage, is most promising as a power storage device in a fuel cell system for portable equipment. It is noted that these secondary batteries tend to deteriorate significantly if overcharged or overdischarged to such an extent that the remaining capacity goes beyond an appropriate range, and therefore, it is desirable to charge and discharge these batteries to keep the remaining capacity within an appropriate range.

Patent Literature 1 proposes detecting a capacity of the secondary battery, and setting a command value of the output of the fuel cell on the basis of the detected capacity, thereby to charge and discharge the secondary battery within an appropriate remaining capacity range. In this method, depending on the capacity of the secondary battery, the command value of the output of the fuel cell is set, and the activation and stop of the fuel cell is instructed.

However, according to the method of Patent Literature 1, it may happen that in association with fluctuations in the power consumption of the load, the fuel cell is frequently activated and stopped repetitively, or the output power is frequently changed. In such events, the power generation efficiency of the fuel cell decreases, and therefore, this method is not always excellent. In particular, a decrease in power generation efficiency due to fluctuations in output is severe in direct oxidation fuel cells in which fuel crossover is likely to occur. A change in the output power creates a temporary imbalance between the current generated from the fuel cell and the amount of fuel supplied. In direct oxidation fuel cells, the imbalance increases the amount of fuel crossover.

The higher the fuel stoichiometric ratio is, the more the amount of fuel crossover increases. In other words, if the amount of fuel supplied is much larger than that required, the fuel concentration at the interface between the anode and the polymer electrolyte membrane increases, and the concentration gradient inside the electrolyte membrane increases. As a result, the fuel diffusion rate within the electrolyte membrane increases, and the amount of fuel crossover increases. The “fuel stoichiometric ratio” herein is a stoichiometric ratio expressed as, for example, a ratio: Fᵣ/Fₜ between an amount of fuel Fₜ corresponding to the current generated, which is calculated using the above formula (11), and an amount of fuel Fᵣ actually supplied. It is to be noted that if the fuel stoichiometric ratio is set extremely low, the fuel concentration within the electrode of the fuel cell is lowered significantly, causing concentration overvoltage, which reduces the voltage generated from the fuel cell and decreases the output. Therefore, in order to achieve high power generation efficiency, it is necessary to appropriately set the fuel stoichiometric ratio.

As described above, as a first step to adjust the output of the fuel cell, the output current of the fuel cell need be adjusted so that a target output power can be obtained. As a next step, the output current is multiplied by a preset fuel stoichiometric ratio, to determine a setting value of an amount of fuel supplied, and the amount of fuel supplied need be adjusted to be equal to the setting value. At this time, the current generated and the amount of fuel supplied can change instantly, whereas the actual change of the fuel concentration within the electrode of the fuel cell appears with a time lag.

For example, in the case of decreasing the output power of the fuel cell, even though the output current and the amount of fuel supplied are reduced simultaneously, there is a fuel buildup in the fuel supply channel for supplying fuel to the anode and in the anode diffusion layer. This results in a situation in which the fuel is present in excess as compared with the amount of fuel actually consumed, increasing the fuel concentration at the interface between the anode and the polymer electrolyte membrane. As a result, the amount of fuel crossover increases.

Conversely, in the case of increasing the output power of the fuel cell, concentration overvoltage due to a fuel shortage becomes more likely to occur. In order to prevent this, the amount of fuel supplied should be increased in advance, and then the output current should be increased. The output power increases with a time lag, during which the fuel is excessively supplied to the anode. As a result, the amount of fuel crossover increases.

Patent Literature 2 proposes, in order to suppress the decrease of power generation efficiency during the time lag of the variable control of the output as mentioned above, switching the output power of the fuel cell only among the limited number of power generation modes. Specifically, the output power of the fuel cell is switched among two or more power generation modes differing in the amount of power to be generated, depending on the remaining capacity of the secondary battery. This can reduces the number of times the output power of the fuel cell is switched. Therefore, the life of the secondary battery is expected to be prolonged, while the power generation efficiency of the fuel cell is kept high.

Patent Literature 3 proposes a technology for accurately grasping the deterioration state of the secondary battery in a fuel cell system, while electric power is supplied to the load. Specifically, when the consumption power of the external load is smaller than the output power of the fuel cell, the charge and discharge of the secondary battery is stopped for a predetermined period of time, and in this state, the open-circuit voltage (OCV) of the secondary battery is measured. The measured OCV is used as the basis on which the deterioration of the secondary battery is to be accurately detected.

### CITATION LIST

### Patent Literature

[PTL 1] Japanese Laid-Open Patent Publication No. 2002-34171
[PTL 2] Japanese Laid-Open Patent Publication No. 2005-38791
[PTL 3] Japanese Laid-Open Patent Publication No. 2003-132960

### SUMMARY OF INVENTION

### Technical Problem

However, the technology disclosed in Patent Literature 3 cannot accurately detect the deterioration of the secondary battery in any situation of use. According to the proposal of Patent Literature 3, the voltage of the secondary battery is measured only when the power consumption of the external load is below a predetermined power being equal to or less than the output power of the fuel cell. However, depending on the type and the condition of use of the load device, it may happen that the power consumption does not drop below the aforementioned predetermined power over several seconds to several hundred seconds. If this happens, the voltage of the secondary battery cannot be measured for a long period of time, during which the deterioration of the secondary battery may proceed.

In Patent Literature 3, in order to grasp the deterioration state of the secondary battery, the difference between the remaining capacity calculated from the measured OCV and the remaining capacity calculated from the quantity of electricity discharged after refresh charging, thereby to grasp the deterioration state of the secondary battery. However, according to this method, it is necessary to employ two different measuring means: a means for measuring an OCV, and a means for measuring a quantity of electricity discharged. In addition, it is necessary to regularly subject the secondary battery to refresh charging, which makes the control system complicated, and may cause the cost to increase.

Furthermore, the internal resistance of the secondary battery increases as the deterioration proceeds. As such, even though the output power of the fuel cell is changed by switching the power generation mode among two or more modes depending on the remaining capacity of the secondary battery, if the power generation mode is switched on the basis of the same conditions as those for the secondary battery in an early stage which is not deteriorated yet, when the secondary battery has already deteriorated to some extent, the deterioration might be accelerated.

In view of the above, the present invention intends to provide a method of controlling a fuel cell system, by which the fuel cell can be operated with high power generation efficiency, and the deterioration of the secondary battery can be suppressed.

### Solution to Problem

One aspect of the present invention relates to a method for controlling a fuel cell system including a fuel cell and a secondary battery, to variably control an output power of the fuel cell. The method includes the steps of:

(i) charging the secondary battery with the output power or discharging the secondary battery, depending on an amount of power supplied to a load and the output power;

(ii) detecting a remaining capacity CR of the secondary battery;

(iii) switching stepwise the output power, depending on the remaining capacity CR;

(iv) detecting the number of cycles of the charging and discharging of the secondary battery; and

(v) correcting conditions for switching the output power, on the basis of the detected number of cycles of the charging and discharging.

Another aspect of the present invention relates to a method for controlling a fuel cell system including a fuel cell and a secondary battery, to variably control an output power of the fuel cell. The method includes the steps of:

(i) charging the secondary battery with the output power or discharging the secondary battery, depending on an amount of power supplied to a load and the output power;

(ii) detecting a remaining capacity CR of the secondary battery;

(iii) comparing the remaining capacity CR with at least one reference value RV, and on the basis of a result of the comparison, selecting one of two or more preset power generation modes of the fuel cell differing in the output power; and

(iv) detecting the number of cycles of the charging and discharging, on the basis of the number of times the power generation mode has been switched.

Yet another aspect of the present invention relates to a fuel cell system including a fuel cell and a secondary battery, to variably control an output power of the fuel cell. The system includes:

a means for charging the secondary battery with the output power or discharging the secondary battery, depending on an amount of power supplied to a load and the output power of the secondary battery;

a means for detecting a remaining capacity CR of the secondary battery;

a means for switching stepwise the output power of the fuel cell, depending on the remaining capacity CR;

a means for detecting the number of cycles of the charging and discharging the secondary battery; and

a means for correcting conditions for switching the output power, on the basis of the detected number of cycles of the charging and discharging.

### Advantageous Effects of Invention

According to the present invention, since the output power of the fuel cell is switched stepwise, the fuel cell can be operated with high power generation efficiency, while the fluctuations in the output power are suppressed. On the other hand, since the number of charge/discharge cycles of the secondary battery is detected, and the conditions for switching the output voltage are corrected on the basis of the detected number, the output voltage of the fuel cell or the charge current of the secondary battery can be adjusted, with taking into account the extent to which the deterioration of the secondary battery has proceeded. Therefore, in a secondary battery having deteriorated to some extent, acceleration of the deterioration can be prevented, and the deterioration of the secondary battery can be suppressed.

Furthermore, since the number of charge/discharge cycles of the secondary battery is detected on the basis of the number of times the power generation mode of the fuel cell has been switched, and on the basis of the detected number, information on life of the secondary is created and outputted, it is possible, for example, to urge the user to replace the secondary battery at an appropriate timing. This makes it possible to prevent inconvenience such as sudden stop of operation of the fuel cell system, and enhance the reliability of the fuel cell system.

### BRIEF DESCRIPTION OF DRAWINGS

FIG. 1 A block diagram of a schematic configuration of a fuel cell system according to one embodiment of the present invention

FIG. 2 An enlarged cross-sectional view of an essential part of a fuel cell included in the fuel cell system

FIG. 3 A graph showing a relationship between the current and voltage of the fuel cell and a relationship between the current and output of the fuel cell

FIG. 4A A graph showing a relationship between the reference value of the remaining capacity for switching the power generation mode and the number of charge/discharge cycles, in one example of the fuel cell system

FIG. 4B A graph showing a relationship between the reference value of the remaining capacity for switching the power generation mode and the number of charge/discharge cycles, in another example of the fuel cell system

FIG. 5 A flowchart of the reference value correction process

FIG. 6 A graph showing a load profile in Examples of the present invention

FIG. 7 A graph showing a relationship between the number of charge/discharge cycles and the capacity retention rate of Examples and Comparative Example of the present invention

FIG. 8A A graph showing changes in the remaining capacity at the 1^{st} charge/discharge cycle of Examples and Comparative Example of the present invention

FIG. 8B A graph showing changes in the remaining capacity at the 801^{th} charge/discharge cycle of Examples and Comparative Example of the present invention

### DESCRIPTION OF EMBODIMENTS

The present invention relates to a method for controlling a fuel cell system including a fuel cell and a secondary battery, to variably control an output power of the fuel cell. The present method includes the step of (i) charging the secondary battery with the output power of the fuel cell or discharging the secondary battery, depending on an amount of power supplied to a load and the output power of the secondary battery. By this step, for example, when the power consumption of the load device decreases to be smaller than the output power of the fuel cell, excess power can be stored in the secondary battery. On the other hand, when the power consumption of the load device increases to be larger than the output power of the fuel cell, the secondary battery is discharged, and the power shortage can be compensated. The foregoing makes it possible to stably supply power required by the load device, and eliminate the necessity of switching the output power of the fuel cell in quick response to fluctuating power consumption of the load device. As a result, various negative effects associated with switching of the operation condition (e.g., increased amount of crossover, and decreased efficiency of power generation) can be suppressed.

The present control method further includes the steps of (ii) detecting a remaining capacity CR of the secondary battery, and (iii) switching stepwise the output power of the fuel cell, depending on the remaining capacity CR. By these steps, an appropriate amount of power can be always stored in the secondary battery, and power can be supplied more stably to the load. Moreover, by switching stepwise the output power of the fuel cell, rather than continuously, frequent switching of the output power can be prevented. As a result, the decrease of power generation efficiency can be more reliably suppressed.

The present control method further includes the steps of (iv) detecting the number of charge/discharge cycles of the secondary battery, and (v) correcting the conditions for switching the output power of the fuel cell, on the basis of the detected number of charge/discharge cycles. In this regard, detailed description is given below.

In secondary batteries, generally, the deterioration proceeds with increase in the number of charge/discharge cycles, and the internal resistance increases. Charging the secondary battery with large current when the secondary battery has an increased internal resistance and is in a high state of charge (SOC) will accelerate the deterioration of the secondary battery. Therefore, in order to suppress the deterioration of the secondary battery to prolong its life, it is preferable to suppress the charge current when the depth of charge of the secondary battery is large. In other words, as the deterioration of the secondary battery proceeds, when the remaining capacity is within a range close to the capacity of the secondary battery in a fully charged state (herein after sometimes referred to as a “high-charge range”), the charge current is preferably set low.

For the reasons above, in the present control method, in variably controlling the output power of the fuel cell on the basis of the remaining capacity CR, the number of charge/discharge cycles of the secondary battery is detected, and on the basis of the detected number, the conditions for switching the output power of the fuel cell is corrected. For example, in a situation where it is estimated from the detected number of charge/discharge cycles that the secondary battery has deteriorated to some extent, the output power of the fuel cell can be switched such that the charge current is set low in a lower state of charge than usual. By doing this, in the high-charge range, the secondary battery is prevented from being charged with high current, and the deterioration of the secondary battery can be suppressed. Furthermore, in the high-charge range, since the secondary battery stores a comparatively large amount of power, the power that should be supplied to the load is unlikely to be in short supply even if the output power of the fuel cell is reduced, and therefore, such control is reasonable.

On the other hand, during the time when the number of charge/discharge cycles of the secondary battery is comparatively small, the deterioration is unlikely to be accelerated even if the secondary battery is charged with a high current in the high-charge range, and therefore, the secondary battery is charged with a comparatively high current until the battery reaches comparatively close to a fully charged state. By doing this, the secondary battery can be charged rapidly to a fully charged state, and the power required by the load device can be supplied more stably.

The fuel cell and the secondary battery to which the present control method can be applied may be of any type without limitation. The life of various secondary batteries can be prolonged by setting the charge current low in the high-charge range when the deterioration of the secondary battery has proceeded. However, in view of improving the power generation efficiency of the fuel cell, when applied to a fuel cell whose power generation efficiency is greatly influenced by fuel crossover, such as a direct oxidization fuel cell, particularly great improvement in the energy conversion efficiency can be achieved. Furthermore, when applied to a lithium ion secondary battery whose internal resistance tends to increase as the deterioration proceeds, prolonged life can be more readily achieved.

For the reasons above, the present control method can be very effectively applied to a fuel cell system including a direct oxidation fuel cell (particularly, a direct methanol fuel cell) and a lithium ion secondary battery. The secondary battery may be an inexpensive secondary battery such as a lead acid battery, thereby to reduce the cost of the system. The number of the secondary batteries may be one, or two or more. For example, a battery pack (a battery group) with high capacity formed by connecting two or more secondary batteries in parallel, or a battery pack with high voltage formed by connecting two or more secondary batteries in series or connecting groups of parallel-connected batteries in series may be used.

In one embodiment of the present invention, the above step (iii) includes comparing the remaining capacity CR with at least one reference value RV, and selecting one of two or more preset power generation modes of the fuel cell differing in the output power. On the basis of the result of the comparison, the above step (v) includes correcting the at least one reference value RV, on the basis of the detected number of charge/discharge cycles.

In short, on the basis of the result of comparison between the remaining capacity CR and at least one reference value RV, one of two or more preset power generation modes is selected, and the reference value is corrected on the basis of the number of charge/discharge cycles of the secondary battery. By doing this, the conditions related to the remaining capacity CR of the secondary battery for switching the power generation mode of the fuel cell can be changed depending on the degree of deterioration of the secondary battery.

It is preferable that in selecting the power generation mode, a power generation mode for a higher output power is selected as the remaining capacity CR decreases. By doing this, the secondary battery can be charged with a high current in a low-charge range in which the remaining capacity CR is small, and can be charged with a low current in a high-charge range in which the remaining capacity CR is large. This makes it possible to stably supply power to the load, as well as to suppress the deterioration of the secondary battery.

Here, it is preferable to detect the number of charge/discharge cycles of the secondary battery, on the basis of the number of times the power generation mode of the fuel cell has been switched. This allows the number of charge/discharge cycles of the secondary battery to be detected without providing a special mechanism for detecting the number of charge/discharge cycles. This further allows the power generation mode to be switched upon occurrence of a fluctuation in the remaining capacity CR across a reference value RV. Here, the reference value RV can be set, with taking into account the relationship between the remaining capacity CR and the influence on the secondary battery of the level of the charge current. Therefore, by detecting the number of charge/discharge cycles of the secondary battery, on the basis of the number of times the power generation mode has been switched, the number of charge/discharge cycles can be detected so as to be more highly associated with the deterioration of the secondary battery.

The deterioration rate of the secondary battery is dependent not only on the number of charge/discharge cycles but also on the ambient temperature and humidity of the fuel cell system and the length of time passed from the beginning of operation of the system (herein after referred to as an “operation time”). Therefore, by monitoring the ambient temperature, the ambient humidity, and the operation time, and by correcting the degree of deterioration (e.g., the degree of increase in the internal resistance) of the secondary battery estimated from the detected number of charge/discharge cycles according to the monitoring result, the degree of deterioration of the secondary battery can be detected more accurately. Consequently, the reference value RV and the like can be corrected more appropriately.

Specifically, the fuel cell system is equipped with a timer, a temperature sensor, and a humidity sensor. In general, the deterioration rate of the secondary battery becomes higher with increase in the ambient temperature and humidity of the secondary battery. Therefore, several temperature ranges and several humidity ranges are preset first, and then, a total length of time passed from the beginning of operation of the system (or a total of the charge/discharge execution time and the rest time) in each of the temperature ranges and of the humidity ranges are calculated. On the other hand, a deterioration acceleration coefficient in each of the temperature ranges and of the humidity ranges (a coefficient based on the deterioration rate at room temperature (e.g., 20° C.) or room humidity (e.g., 65%) is determined in advance. The total length of time in each of the temperature ranges and of the humidity ranges is multiplied by the coefficient. By doing this, it is possible to determine an operation time of the secondary battery so as to reflect the influence of the ambient temperature and humidity of the secondary battery on the deterioration, and thus to determine a correction value according to the operation time. By adding the determined correction value to the degree of deterioration determined on the basis of the number of charge/discharge cycles, the degree of deterioration of the secondary battery can be determined so as to reflect the operation time of the system, the ambient temperature, and the ambient humidity.

The extent to which the deterioration of the secondary battery has proceeded due to repetitive charging and discharging (hereinafter, said extent is sometimes simply referred to as a “cycle deterioration degree”) itself is also influenced by the ambient temperature and the ambient humidity. Therefore, by correcting the estimated increasing rate of deterioration per cycle (i.e., the cycle deterioration rate) according to the ambient temperature and the ambient humidity, and adding the corrected rate of deterioration one after another, the deterioration of the secondary battery can be determined more accurately, on the basis of the number of charge/discharge cycles.

In a control method according to a preferable embodiment of the present invention, two or more different reference values RV₁, RV₂, . . . , RVⁿ, where RV₁>RV₂> . . . >RVₙ, are set as the at least one reference value RV. This allows for more detailed setting of the output power of the fuel cell, and makes it possible to achieve both the stable power supply and the suppression of deterioration of the secondary battery in a more balanced manner.

At this time, it is preferable to detect the number of charge/discharge cycles on the basis of the number of times the remaining capacity CR has shifted from a value equal to or more than RV₁ to a value less than RV₁, and the number of times the remaining capacity CR has shifted from a value less than RVₙ to a value equal to or more than RVₙ. By detecting the number of charge/discharge cycles on the basis of the numbers as above, the number of charge/discharge cycles can be calculated, with a discharge from a nearly fully charged state to a nearly fully discharged state and a charge from a nearly fully discharged state to a nearly fully charged state being taken as one set. Therefore, the detected number of charge/discharge cycles can more accurately reflect the degree of deterioration of the secondary battery.

The remaining capacity CR is preferably detected on the basis of the voltage of the secondary battery. This allows for easy detection of the remaining capacity CR, and thus can simplify the system and reduce the cost of the system. The remaining capacity CR can be alternatively measured by, for example, integrating the quantity of electricity discharged from a fully charged state and the quantity of electricity charged.

Here, in the case where the secondary battery is a battery group or a battery pack comprising two or more secondary batteries connected in parallel and/or in series, the remaining capacity CR may be determined by measuring voltages of the individual secondary batteries to obtain remaining capacities of the individual secondary batteries, and adding up the obtained values. Alternatively, the remaining capacity CR may be determined by measuring a voltage of the battery group or battery pack as a whole.

In the case where the remaining capacity CR is detected on the basis of the voltage of the secondary battery, it is preferable to detect a voltage of a capacitor connected in parallel with the secondary battery, and detect a voltage of the secondary battery on the basis of the detected value. The voltage of such a capacitor shows an average voltage of the secondary battery for a certain period of time. Hence, the influence of temporary fluctuations in voltage is excluded, and the remaining capacity CR can be determined more accurately on the basis of the voltage of the secondary battery. As a result, even if, for example, the voltage of the secondary battery widely fluctuates temporarily, the power generation mode will not be switched in association with the fluctuations, and useless switching of the power generation mode can be suppressed. Therefore, while the drawbacks associated with switching of the power generation mode, such as reduction in efficiency, can be minimized, the amount of power stored in the secondary battery can be adjusted more appropriately.

In one possible embodiment of the method for controlling a fuel cell system of the present invention, regardless of whether the conditions for switching the power generation mode of the fuel cell are corrected or not, the number of charge/discharge cycles is detected or estimated on the basis of the number of times the power generation mode has been switched. By doing this, the number of charge/discharge cycles of the secondary battery can be easily known.

A method for controlling a fuel cell system according to another preferable embodiment of the present invention further comprises the step of creating and outputting information on life of the secondary battery, on the basis of the detected or estimated number of charge/discharge cycles. When the life of the secondary battery in the fuel cell system reaches its end, it becomes difficult to keep storing an appropriate amount of power in the secondary battery, and thus difficult to stably supply power to the load device. According to this embodiment, since information on life of the secondary battery is outputted, the user can prepare for replacement of the secondary battery and the like, and the reliability of the fuel cell system can be enhanced.

Here, the information on life can be outputted via the fuel cell system or the user interface of the load device. The information on life may include: the number of times the power generation mode has been switched, the number of charge/discharge cycles calculated on the basis thereof, the degree of deterioration of the secondary battery estimated on the basis of the number of charge/discharge cycles, and a predicted value of the remaining number of charge/discharge cycles or operable time of the system until the life of the secondary battery expires.

The information on life may be outputted as a message displayed on a liquid crystal display, an LED display, or the like, or alternatively as a visual sign such as lighting or blinking of an alarm lamp, thereby to urge the user to replace the secondary battery. In the case of outputting as a visual sign also, the length of remaining life can be notified by changing the speed of blinking or changing the color of the alarm lamp. Alternatively, the information on life may be outputted as a voice message, or as a simple alarm sound (audio sign), thereby to urge the user to replace the secondary battery. In the case of outputting as an audio sign also, the length of remaining life can be notified by changing the interval of outputting the alarm sound or changing the wavelength of the alarm sound.

With regard to the life of the secondary battery included in a fuel cell system, the matters to be noted are described below. The secondary battery included in a fuel cell system differs from a general secondary battery in that the former is used as an auxiliary power source.

In general, in the case where a secondary battery is used as a main power source for an electric device, the life of the secondary battery is regarded as having reached its end when the capacity is reduced to 70 to 80% of the capacity at the beginning of use, although the percentage is a little higher or lower depending on the type of the electric device.

In contrast, in the case where a secondary battery is used as an auxiliary power source in a fuel cell system, rather than as a main power souse for an electric device, the secondary battery can be used longer until the capacity is much further reduced. This is because the minimum function required for a secondary battery used as an auxiliary power source in a fuel cell system is to store a power for running the pumps and electric circuits for supplying fuel or air to the fuel cell after the fuel cell is activated and before it starts generating power.

From the above point of view, the life of the secondary battery can be determined referring to a capacity of the secondary battery, with a quantity of electricity required for activating the fuel cell (a minimum capacity) plus a margin taken as a reference capacity. For example, in a system in which the percentage of the quantity of electricity discharged from the secondary battery in the power supplied to the load device is low, the above reference capacity can be used as it is to determine a life of the secondary battery. In this case, the life of the secondary battery may be alternatively judged as having reached its end when, for example, the ratio of the present capacity to the initial capacity (hereinafter sometimes referred to as a “capacity retention rate”) is reduced to as low as 20%.

On the other hand, in a system in which the percentage of the quantity of electricity discharge from the secondary battery in the power supplied to the load device is high, reduction in capacity of the secondary battery tends to result in failure of stable power supply to the load device. Therefore, in such a system, it is necessary to judge the life of the secondary battery as having reached its end at a timing when the capacity retention rate is still higher than that in the aforementioned system. In such a case, a similar judging criterion to that used when the secondary battery serves as a main power source is preferably used to judge the life of the secondary battery.

A fuel cell system according to yet another embodiment of the present invention relates to a fuel cell system including a fuel cell and a secondary battery, to variably control an output power of the fuel cell. The system includes: a means for charging the secondary battery with the output power of the fuel cell or discharging the secondary battery, depending on an amount of power supplied to a load and the output power of the secondary battery; a means for detecting a remaining capacity CR of the secondary battery; a means for switching stepwise the output power of the fuel cell, depending on the remaining capacity CR; a means for detecting the number of cycles of the charging and discharging the secondary battery; and a means for correcting the conditions for switching the output power, on the basis of the detected number of cycles of the charging and discharging.

Description is given below of embodiments of the present invention, with reference to the appended drawings.

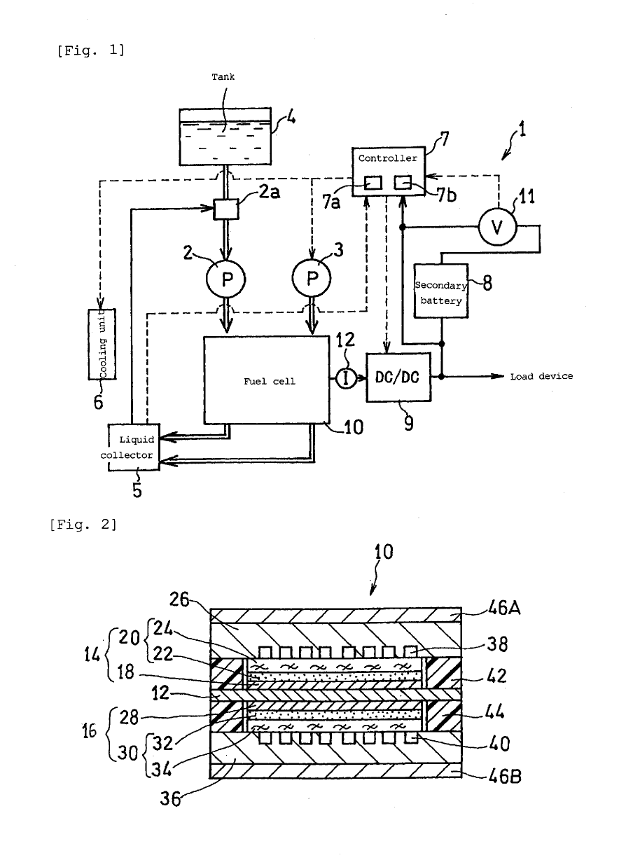

FIG. 1 is a block diagram of a schematic configuration of a fuel cell system according to one embodiment of the present invention. FIG. 2 is a cross-sectional view of a schematic configuration of a fuel cell included in the fuel cell system.

Firstly, referring to FIG. 2, the structure of a fuel cell included in the system of FIG. 1 is described. A fuel cell 10 including only one cell is illustrated in FIG. 2 for ease of description. However, the fuel cell may include a cell stack comprising two or more cells electrically connected to each other in series. The fuel cell 10 included in the fuel cell system 1 shown in FIG. 1, irrespective of FIG. 2, may include two or more cells so that required output power can be obtained.

The fuel cell 10 illustrated in the figure is a direct methanol fuel cell (DMFC), and includes a polymer electrolyte membrane 12, and an anode 14 and a cathode 16 sandwiching the polymer electrolyte membrane 12. The polymer electrolyte membrane 12 has hydrogen ion conductivity. To the anode 14, methanol is supplied as a fuel. To the cathode 16, air is supplied as an oxidant. A combined object of the anode 14, the cathode 16 and the polymer electrolyte membrane 12 interposed therebetween is called a membrane electrode assembly (MEA). One MEA constitutes the aforementioned one cell.

In the layered direction of the anode 14, the polymer electrolyte membrane 12 and the cathode 16, on the outside of the anode 14 (the upper side in the drawing), a plate-like anode-side separator 26 is disposed such that one surface thereof contacts the anode 14. On the outside of the anode-side separator 26, an end plate 46A is disposed in contact with the anode-side separator 26. In the above layered direction, on the outside of the cathode 16 (the lower side in the drawing), a plate-like cathode-side separator 36 is disposed such that one surface thereof contacts the cathode 16. On the outside of the cathode-side separator 36, an end plate 46B is disposed in contact with the cathode-side separator 36.

In the case where the fuel cell 10 includes a cell stack comprising two or more cells, the end plates 46A and 46B may be disposed only on both ends of the cell stack, instead of being disposed in each cell. The cathode 16 of another cell may be disposed in contact with the other surface of the anode-side separator 26. The anode 14 of another cell may be disposed in contact with the other surface of the cathode-side separator 36.

A gasket 42 is disposed around the anode 14 so as to be sandwiched between the peripheral portions of the anode-side separator 26 and the polymer electrolyte membrane 12. A gasket 44 is disposed around the cathode 16 so as to be sandwiched between the peripheral portions of the cathode-side separator 36 and the polymer electrolyte membrane 12. The gaskets 42 and 44 prevent the fuel and the oxidant from leaking out of the anode 14 and the cathode 16, respectively.

The pair of end plates 46A and 46B is clamped with bolts and springs (not shown), so as to apply pressure to the separators and the MEA. The adhesion at the interfaces between the MEA and the anode-side separator 26 and between the MEA and the cathode-side separator 36 is not good. By applying pressure to the separators and the MEA as described above, the adhesion between the MEA and each of the separators is improved. As a result, the contact resistance between the MEA and each of the separators can be reduced.

The anode 14 includes an anode catalyst layer 18 and an anode diffusion layer 20 being in contact with each other. The anode catalyst layer 18 is in contact with the polymer electrolyte membrane 12. The anode diffusion layer 20 includes an anode porous substrate 24 having been subjected to water-repellent treatment and being in contact with the anode-side separator 26, and an anode water-repellent layer 22 made of a highly water-repellent material and formed on a surface of the anode porous substrate 24. The anode water-repellent layer 22 is in contact with the anode catalyst layer 18.

The cathode 16 includes a cathode catalyst layer 28 and a cathode diffusion layer 30 being in contact with each other. The cathode catalyst layer 28 is in contact with the polymer electrolyte membrane 12. The cathode diffusion layer 30 includes a cathode porous substrate 34 having been subjected to water-repellent treatment and being in contact with the cathode-side separator 36, and a cathode water-repellent layer 32 made of a highly water-repellent material and formed on a surface of the cathode porous substrate 34. The cathode water-repellent layer 32 is in contact with the cathode catalyst layer 28.

A layered body comprising the polymer electrolyte membrane 12, the anode catalyst layer 18 and the cathode catalyst layer 28 carries out power generation in a fuel cell, and is called a catalyst coated membrane (CCM). In other words, the MEA is a combination of the CCM and the anode and cathode diffusion layers 20 and 30. The anode and cathode diffusion layers 20 and 30 serve to uniformly disperse the fuel or oxidant supplied to the anode 14 and the cathode 16, as well as to smoothly discharge the reaction products such as water and carbon dioxide.

The anode-side separator 26 has, on its surface contacting the anode porous substrate 24, a fuel flow channel 38 for supplying fuel to the anode 14. The fuel flow channel 38 is formed of, for example, a recess or groove formed on the above contact surface and being open toward the anode porous substrate 24.

The cathode-side separator 36 has, on its surface contacting the cathode porous substrate 34, an air flow channel 40 for supplying oxidant (air) to the cathode 16. The air flow channel 40 is formed of, for example, a recess or groove formed on the above contact surface and being open toward the cathode porous substrate 34.

The fuel flow channel 38 on the anode-side separator 26 and the air flow channel 40 on the cathode-side separator 36 may be formed by, for example, producing separators first, and then grooving the surface of each of the separators. Alternatively, the fuel flow channel 38 and the air flow channel 40 may be formed at the same time when separators are produced by molding, such as injection molding or compression molding.

The anode catalyst layer 18 includes a particulate anode catalyst for accelerating the reaction represented by the aforementioned formula (11), and a polymer electrolyte for ensuring the ion conductivity between the anode catalyst layer 18 and the polymer electrolyte membrane 12. Examples of the polymer electrolyte contained in the anode catalyst layer 18 include perfluorosulfonic acid/polytetrafluoroethylene copolymer (H⁺ type), sulfonated polyethersulfone (H⁺ type), and aminated polyethersulfone (OH⁻ type).

The particulate anode catalyst may be supported on a carrier of conductive carbon particles such as carbon black. The particulate anode catalyst may be an alloy of platinum (Pt) and ruthenium (Ru), or a mixture of Pt and Ru. In order to increase the reaction sites of the particulate anode catalyst and improve the reaction speed, the size of the particulate anode catalyst is preferably as small as possible. The average particle size of the particulate anode catalyst may be set to 1 to 20 nm.

The cathode catalyst layer 28 includes a particulate cathode catalyst for accelerating the reaction represented by the aforementioned formula (12), and a polymer electrolyte for ensuring the ion conductivity between the cathode catalyst layer 28 and the polymer electrolyte membrane 12. Examples of the polymer electrolyte contained in the cathode catalyst layer 28 are the same as those of the polymer electrolyte contained in the anode catalyst layer 18.

The particulate cathode catalyst may be used alone or supported on a carrier of conductive carbon particles such as carbon black. The particulate cathode catalyst may be, for example, Pt or a Pt alloy. Examples of the Pt alloy include an alloy of Pt and a transition metal such as cobalt or iron.

The polymer electrolyte membrane 12 may be made of any material without limitation, as long as the polymer electrolyte membrane 12 can have ion conductivity. For example, various polymer electrolyte materials known in the art may be used as such a material. Most of the polymer electrolyte membranes currently available is an electrolyte membrane having hydrogen ion conductivity.

A specific example of the polymer electrolyte membrane 12 is a fluoropolymer membrane. The fluoropolymer membrane is exemplified by a polymer membrane containing a perfluorosulfonic acid polymer such as perfluorosulfonic acid/polytetrafluoroethylene copolymer (H⁺ type). The membrane containing a perfluorosulfonic acid polymer is exemplified by a Nafion membrane: trade name “Nafion” (a registered trademark of E. I. du Pont de Nemours and Company).

The polymer electrolyte membrane 12 preferably has a function to reduce crossover of fuel (e.g., methanol) used in a fuel cell. Examples of a polymer electrolyte membrane having such a function include: in addition to the aforementioned fluoropolymer membrane, a membrane containing a hydrocarbon-based polymer free of fluorine atoms, such as sulfonated polyether ether sulfone (S-PEEK); and a composite membrane of an organic material and an inorganic material.

Examples of a porous substrate used as the anode and cathode porous substrates 24 and 34 include: a material containing carbon fibers, such as carbon paper, carbon cloth, and carbon nonwoven fabric (e.g., carbon felt); corrosion resistant metal mesh; and foamed metal.

Examples of a highly water-repellent material used for the anode and cathode water-repellent layers 22 and 32 include a fluoropolymer and fluorinated graphite. The fluoropolymer is exemplified by polytetrafluoroethylene (PTFE).

The anode-side and cathode-side separators 26 and 36 are made of, for example, a carbon material, such as graphite. The separator serves as in insulator for preventing cell-to-cell migration of chemical substances, and serves to conduct electrons between cells and electrically connect the cells to each other in series.

A material constituting the gaskets 42 and 44 may be, for example, a fluoropolymer, such as PTFE and tetrafluoroethylene-hexafluoropropylene copolymer (FEP); a synthetic rubber, such as fluorine rubber and ethylene-propylene-diene (EPDM) rubber; and a silicone elastomer. The gaskets 42 and 44 can be made by, for example, providing an opening for accommodating the anode or cathode, at the center portion of a PTFE sheet.

The output voltage per unit cell of a direct oxidation fuel cell is 0.3 to 0.5 V. When a fuel cell stack is formed by stacking a plurality of cells and electrically connecting the cells in series, the output voltage of the fuel cell stack is equal to a value obtained by multiplying the output voltage per unit cell by the number of cells stacked. In general, considerably increasing the number of cells stacked increases the number of component parts and the number of assembling processes of a fuel cell stack, and increases the production cost. For this reason, the voltage generated from the fuel cell stack is converted into a higher voltage by a DC-DC converter 9, and then supplied to an electric device or an inverter for generating alternating current.

Next, referring to FIG. 1, the configuration of the fuel cell system of the present invention is described.

The fuel cell system 1 illustrated in the figure includes the fuel cell (cell stack) 10, a fuel pump 2 for pumping fuel from a fuel tank 4 into the cathode, an air pump 3 for pumping air into the cathode, a liquid collector 5 for collecting and storing liquid effluent from the anode and cathode, a cooling unit 6 for cooling the fuel cell system, a controller 7 for controlling the operation condition of the entire system, a secondary battery 8 for storing power output from the fuel cell stack, the DC-DC converter 9, a voltage sensor 11 for detecting a voltage of the secondary battery, and a current sensor 12 for detecting an output current of the fuel cell 10. The fuel cell system 1 may further include an inverter for converting the output (direct current power) from the DC-DC converter 9 into alternating current power and outputting the alternating current power.

The controller 7 further includes an arithmetic unit 7a and a memory unit 7b for performing a computation for variably controlling the output power of the fuel cell 10. It is to be noted that the controller 7 may not necessarily include the arithmetic and memory units 7a and 7b, and the arithmetic and memory units 7a and 7b may be provided separately from the controller 7. However, the arithmetic and memory units 7a and 7b exchange information reciprocally and frequently with the controller 7, and execute a part of process to be performed by the controller 7. For this reason, as a preferable embodiment, the arithmetic and memory units 7a and 7b are incorporated in the controller 7 in the fuel cell system 1 illustrated in the figure. Accordingly, in FIG. 1, the connecting lines between the arithmetic unit 7a and the memory unit 7b are not shown.

The arithmetic unit 7a may be, for example, a central processing unit (CPU), or a microcomputer (MPU). The arithmetic unit 7a may include software for performing various computations as described later, and/or various logic circuits. The memory unit 7b may be, for example, a memory. The controller 7 itself excluding the arithmetic and memory units 7a and 7b may include an arithmetic device, a memory, and various software and/or various logic circuits. In general, a personal computer (PC) or microcomputer may be used as the controller 7. In this case, the arithmetic and memory units 7a and 7b may be configured to share the same hardware with the controller 7 itself.

The input terminal of the DC-DC converter 9 is connected to the fuel cell 10, and the output terminal is connected to an electric device (or an inverter) (not shown). The output terminal of the DC-DC converter 9 is also connected to the secondary battery 8. As such, of the output power of the fuel cell 10 sent via the DC-DC converter 9, the output power not sent to the electric device is sent to the secondary battery and stored therein. The power stored in the secondary battery 8 is discharged as needed, and sent to the load device. The DC-DC converter 9 converts the output of the fuel cell 10 into desired voltage in accordance with a command from the controller 7.

In the fuel cell system 1 illustrated in the figure, the fuel pump 2 and the fuel tank 4 constitute a fuel supply unit. On the other hand, the air pump 3 constitutes an oxidant supply unit. The cooling unit 6 may be, for example, a ventilator. Examples of the ventilator include: fans, such as sirocco fans, turbo fans, axial flow fans, and cross flow fans; blowers, such as centrifugal blowers, axial flow blowers, and volume blowers; and fan motors. The cooling unit 6 may be of air cooling type or water cooling type.

In the fuel cell system 1 illustrated in the figure, the voltage sensor 11 constitutes a means for detecting a remaining capacity CR. The fuel pump 2 and the air pump 3 may be a feed pump. The feed pump is exemplified by a micropump including a piezoelectric element and a diaphragm. The oxidant supply unit is not limited to the air pump 3, and may take a form that supplies an oxidant using, for example, an oxygen tank. On the other hand, the air supply unit is not limited to a form that positively supplies fuel via a pump or the like, and may take a form that supplies fuel utilizing, for example, capillarity. The remaining capacity CR is not necessarily determined from the voltage of the secondary battery 8, and may be determined by integrating the quantity of charged electricity and the quantity of discharged electricity as described above. In the latter case, the voltage sensor 11 and the current sensor 12 constitute a means for detecting a remaining capacity CR.

The fuel tank 4 stores methanol or an aqueous methanol solution as a fuel. The fuel stored in the fuel tank 4 is sent to the anode 14 of the fuel cell 10 via the fuel pump 2. The fuel from the fuel tank 4 enters a mixing unit (mixing tank) 2a where it is mixed with a collected liquid (water or an aqueous methanol solution with low concentration) from the liquid collector 5, and diluted. The diluted fuel is then sent to the fuel cell 10 via the fuel pump 2. The mixing unit 2a may be incorporated in the fuel pump 2.

The reason why methanol is diluted before being sent to the fuel cell 10 is that supplying an aqueous methanol solution with high concentration to the anode 14 increases methanol crossover (MCO) significantly. Therefore, in the case where the diluted aqueous methanol solution is stored in the fuel tank 4, fuel can be directly sent from the fuel tank 4 to the fuel cell 10.

On the other hand, air serving as an oxidant is sent via the air pump 3 to the cathode 16 of the fuel cell 10. Water is produced at the cathode 16. Part of the produced water is collected by the liquid collector 5, and stored therein in the form of liquid water, which is then used for the aforementioned fuel dilution. Excess water, in the form of water vapor, is separated together with air supplied to the cathode 6 through a gas-liquid separation membrane disposed in the liquid collector 5, and externally discharged from the liquid collector 5. Carbon dioxide produced at the anode 14 during power generation is also separated through the gas-liquid separation membrane and externally discharged from the liquid collector 5.

The liquid collector 5 is, for example, a container having an opening at the top and a gas-liquid separation membrane (not shown) disposed so as to close the opening. The gas-liquid separation membrane separates liquid, i.e., water and unused fuel, from gas, i.e., air, water vapor and carbon dioxide. The liquid collector 5 is preferably equipped with a sensor (water level sensor) for detecting an amount of water stored therein.

The value detected by the water level sensor is transmitted to the controller 7. When water is stored in excess in the liquid collector 5 due to long time operation of the fuel cell 10, the controller 7 increases the output of the air pump 3 to allow more air to circulate within the liquid collector 5, thereby to increase the amount of water to be released outside as water vapor. Conversely, when water in the liquid collector 5 is in shortage, the controller 7 puts the cooling unit 6 in full operation to decrease the temperature of the fuel cell 10 or the temperature of the liquid collector 5, thereby to reduce the amount of water vapor to be released from the liquid collector 5. In such a manner, the liquid collector 5 operates in corporation with the controller 7, the air pump 3, and the cooling unit 6, to keep an appropriate amount of water in the system.

The secondary battery 8 may be, for example, a nickel-metal hydride storage battery, a nickel-cadmium storage battery, or a lithium ion secondary battery. Among them, a lithium ion secondary battery is suitable for the fuel cell system of the present invention because of its high output and high energy density. The secondary battery 8 may be a battery group or battery pack comprising two or more secondary batteries connected in parallel or series. The direct current output voltage of a general power source device is 12 V or 24 V. Therefore, in the case of a lithium ion battery, a battery pack comprising four or seven cells connected in series is used. Alternatively, depending on the capacity required for the secondary battery 8, two or more cells are connected in parallel.

Next, variable control of the output power of the fuel cell 10 carried out in the fuel cell system 1 is described.

In the fuel cell system 1 of FIG. 1, the fuel cell 10 operates in two or more power generation modes differing in the output power. The power generation mode is switched by a power generation mode selection processing executed by the arithmetic unit 7a in the controller 7 (a means for switching stepwise the output power). In the power generation mode selection processing, the information stored in the memory unit 7b is referred to, and a power generation mode is selected on the basis of the voltage or remaining capacity CR of the secondary battery 8. The information stored in the memory unit 7b include: information to show the relationship between the voltage and remaining capacity CR of the secondary battery 8, information on the reference values RV being the conditions for switching the output power of the fuel cell 10, and information on the number of times the power generation mode has been switched.

Basically, the controller 7 controls the DC-DC converter 9 on the basis of the magnitude relationship between the output power of the fuel cell 10 and the power consumption of the load device, so that the DC-DC converter 9 can output a voltage suitable for charging the secondary battery 8 or a voltage suitable for performing discharge from the secondary battery 8 (a means for charging the secondary battery with the output power of the fuel cell or discharging the secondary battery). As a result of such control by the controller 7, the remaining capacity CR of the secondary battery 8 increases and decreases.

In the system illustrated in the figure, the remaining capacity CR is detected when the arithmetic unit 7a executes a predetermined computation on the basis of the voltage of the secondary battery 8 detected by the voltage sensor 11 (a means for detecting a remaining capacity CR). Specifically, the arithmetic unit 7a refers the information stored in the memory unit 7b on the relationship between the voltage and remaining capacity CR of the secondary battery 8, and detects a remaining capacity CR on the basis of the value detected by the voltage sensor 11. For the voltage used as the basis of detection of a remaining capacity CR, an open-circuit voltage of the secondary battery 8 may be detected, or alternatively, a closed-circuit voltage may be measured with a comparatively light load connected thereto. In the case where the secondary battery 8 is a battery pack, the voltage of the battery pack as a whole may be measured, or alternatively, the voltage of each cell may be measured.

If the remaining capacity CR is determined from a small number of the voltage measurement results, the resultant remaining capacity CR might deviate from the actual remaining capacity CR. For example, in the case where the load fluctuates widely and rapidly, the battery voltage fluctuates greatly, creating a large deviation. Therefore, it is preferable to measure a voltage of the secondary battery a plurality of times for a certain period of time, and average the measurement results as the voltage of the secondary battery 8.

With regard to this, alternatively, a capacitor may be connected in parallel with the secondary battery 8, and the voltage across the terminals of the capacitor may be measured as an average voltage of the secondary battery. The voltage of the capacitor is not influenced by the voltage fluctuating widely in a short period of time and shows an average voltage for a certain period of time. Therefore, a computation of averaging the voltages can be omitted, which makes it possible to avoid the computation from becoming complicated. Furthermore, the voltage of the secondary battery can be measured accurately without electrical grounding, which increases the flexibility in configuring the circuit.

In the power generation mode selection processing, the remaining capacity CR is compared with the reference value RV stored in the memory unit 7b, and on the basis of the result of comparison, a power generation mode of the fuel cell 10 is selected. The controller 7 sets an amount of fuel to be supplied to the fuel cell 10 via the fuel pump 2 and a flow rate of air to be supplied to the fuel cell 10 via the air pump 3 so that an output power corresponding to the power generation mode selected by the power generation mode selection processing can be obtained. At the same time, the controller 7 sets an output voltage of the DC-DC converter 9 so that charge or discharge of the secondary battery 8 can be performed.

When switching the power generation mode according to the result of the power generation mode selection processing, the controller 7 outputs a command signal to the DC-DC converter 9 to switch the power generation mode. The arithmetic unit 7a can directly update the information stored in the memory unit 7b regarding the number of times the power generation mode has been switched, on the basis of the result of the power generation mode selection processing, or alternatively, can monitor the switching command signal outputted by the controller 7 and update the information stored in the memory unit 7b regarding the number of times the power generation mode has been switched, on the basis of the result of monitoring. By the above process, the accumulated number of times of switching of the power generation mode is stored in the memory unit 7b.

Next, a power generation mode setting processing for setting a power generation mode of the fuel cell system is described below.

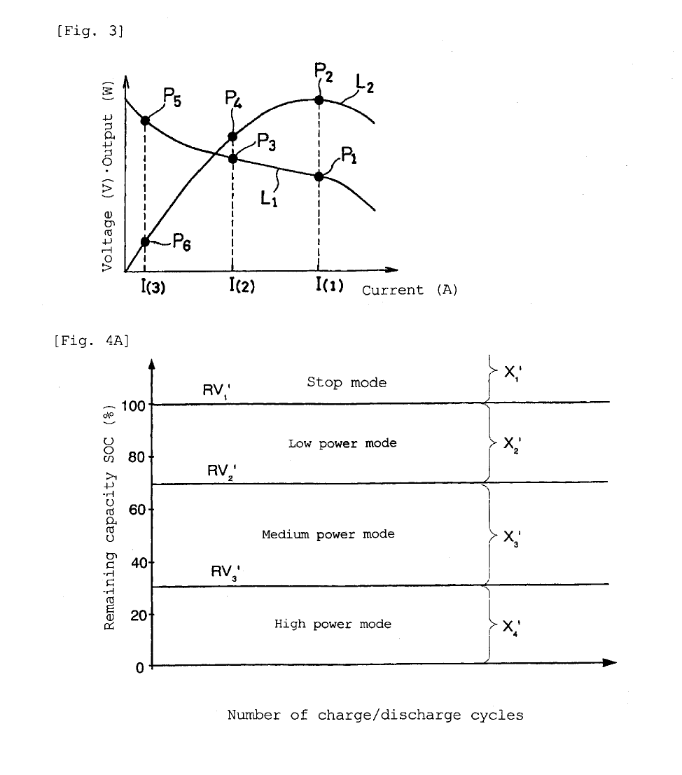

FIG. 3 is a graph obtained by plotting the relationship between the current and voltage of the fuel cell in a steady state (a current-voltage curve L₁) and the relationship between the current and output power of the fuel cell in a steady state (a current-output curve L₂). As shown in FIG. 3, the output power of the fuel cell 10 can be controlled by adjusting the output current or output voltage of the fuel cell 10. Therefore, by allowing the controller 7 to command an input voltage to the DC-DC converter 9 so that a target output power of the fuel cell can be obtained, the output power of the fuel cell is controlled to be equal to the target value.

As understood from FIG. 3, generally, the fuel cell 10 can operate at any point on the current-voltage curve L₁ and the current-output curve L₂. In other words, the output power of the fuel cell 10 can be changed continuously by continuously changing the output voltage or output current of the fuel cell 10. However, as described above, such controlling of the output power of the fuel cell 10 would decrease the fuel utilization rate in association with fluctuations in output, and complicate the control. Therefore, in the fuel cell system 1 illustrated in the figure, the output power of the fuel cell 10 is switched stepwise among a limited number of power generation modes.

Examples of the power generation modes are shown in FIG. 3 as points P₁ and P₂ corresponding to “high power mode (power generation mode for a maximum output power)”, points P₃ and P₄ corresponding to “medium power mode (power generation mode for a medium output power)”, and points P₅ and P₆ corresponding to “low power mode (power generation mode for a low output power)”. Although not shown in the figure, another possible example of the power generation mode is “stop mode (power generation mode for zero output power)”.

Specifically, “high power mode” is a power generation mode under the assumption that the remaining capacity CR is in a range close to a fully discharged state of the secondary battery (e.g., in terms of SOC, a range of less than 30%), and in this mode, the fuel cell 10 operates at a current value I(1) with which the output becomes the highest on the current-output curve L₂. “Medium power mode” is a power generation mode under the assumption that the remaining capacity CR is in a medium range (e.g., in terms of SOC, a range of 30 to 70%), and in this mode, the fuel cell 10 operates at a current value I(2) with which the output becomes 40 to 80% of the output in high power mode on the current-output curve L₂. “Low power mode” is a power generation mode under the assumption that the remaining capacity CR is in a range close to a fully charged state of the secondary battery (e.g., in terms of SOC, a range of more than 70%), and in this mode, the fuel cell 10 operates at a current value I(3) with which the output becomes 10 to 40% of the output in high power mode on the current-output curve L₂. “Stop mode” is a power generation mode under the assumption that the secondary battery is in a fully charged state, and in this mode, the fuel pump 2 and the air pump 3 stop working, and the power generation by the fuel cell 10 is stopped.

In the examples above, in order to decrease the frequency of switching the power generation mode, thereby to improve the power generation efficiency of the fuel cell, the range of the remaining capacity CR within which the fuel cell operates in “medium power mode” is preferably set wide. For example, the range of remaining capacity CR in “medium power mode” preferably has a width of 20 to 40%, with the SOC of the entire capacity of the battery taken as 100%. Especially in the case where the secondary battery is a lithium ion battery, the deterioration is best suppressed when the remaining capacity is kept in the medium range. Therefore, the median of the remaining capacity in “medium power mode” is preferably within the range of 40 to 60% in terms of SOC.

It is to be noted that in the examples above, the timing of switching to “stop mode” is not limited to when the remaining capacity CR reached 100% SOC. In order to prevent some of the secondary batteries from being overcharged due to the influence of changes in temperature or the variations in capacity among cells in a battery pack, the timing can be controlled such that the power generation mode is switched to “stop mode” when the remaining capacity CR exceeds a reference value set within the range of 80 to 100% in terms of SOC.

In the following, taking as an example the case where four power generation modes as described above are preset, the power generation mode setting processing of Embodiment 1 is more specifically described.

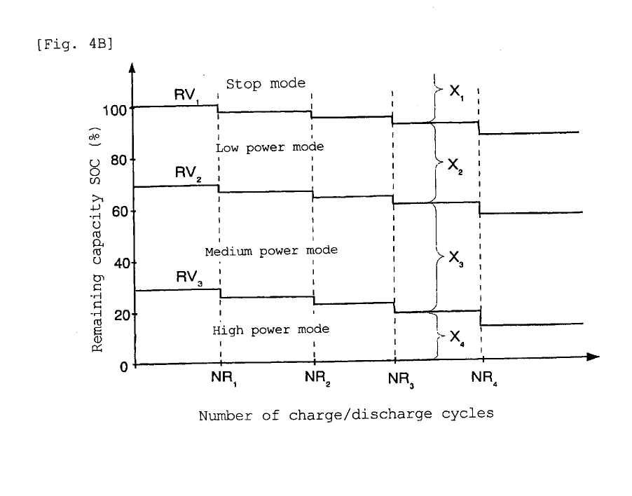

FIG. 4A shows a relationship between the number of charge/discharge cycles of the secondary battery and the reference value of the remaining capacity CR for switching the power generation mode, in the case where the reference value is set constant. In FIG. 4A, four ranges X₁′ to X₄′ of the remaining capacity CR are set so as to correspond to the four power generation modes as described above, respectively. At the boundaries between these ranges, three reference values RV₁′ to RV₃′ which are constant regardless of the number of charge/discharge cycles are set.

FIG. 4B shows a relationship between the number of charge/discharge cycles of the secondary battery and the reference value of the remaining capacity CR for switching the power generation mode, in the case where the reference value is to be corrected. In FIG. 4B, four ranges X₁ to X₄ of the remaining capacity CR are set so as to correspond to the four power generation modes as described above, respectively. At the boundaries between these ranges, three reference values RV₁ to RV₃ which are to be corrected such that the value becomes small stepwise as the number of charge/discharge cycles increases are set.

Next, description is given of fuel stoichiometry. The fuel stoichiometry Fₛₜₒ is a coefficient obtained by dividing the amount of fuel supplied to the anode by the amount of fuel converted from the current generated, i.e., the amount of fuel actually used to generate power, and is given by the following formula (1):

Fₛₜₒ=(I₁+I₂)/I₁ (1)

where I₁ is the current generated, and I₂ is the value of current converted from the sum of the amount of unconsumed fuel and the fuel amount of MCO.

The controller 7 determines an amount of fuel supplied (the amount of fuel converted from I₁+I₂), on the basis of the information on the value of current generated from the fuel cell 10 detected by the current sensor 12 and the set fuel stoichiometry Fₛₜₒ. The controller 7 further sends a control signal to the fuel pump 2 so that the fuel pump 2 can supply fuel in an amount as determined as above, with taking into account the concentration of fuel supplied to the anode 14.

The fuel utilization rate Fᵤₜᵢ is given by the following formula (2):

Fᵤₜᵢ=I₁/(I₁+I₁+I_{MCO}) (2),

where I_{MCO} is the value of current converted from the amount of fuel corresponding to MCO.

Of the fuel supplied to the fuel cell 10, the excess fuel corresponding to the amount of fuel converted from current I₂ (hereinafter referred to as “amount of excess fuel F₁₂”) remains unconsumed in the fuel cell 10 and supplied again to the fuel cell 10 via the liquid collector 5. It is to be noted that in the case where the fuel stoichiometry Fₛₜₒ is set sufficiently low, the amount of excess fuel F₁₂ becomes very small, and the amount of fuel contained in the effluent from the fuel cell 10 becomes very small.

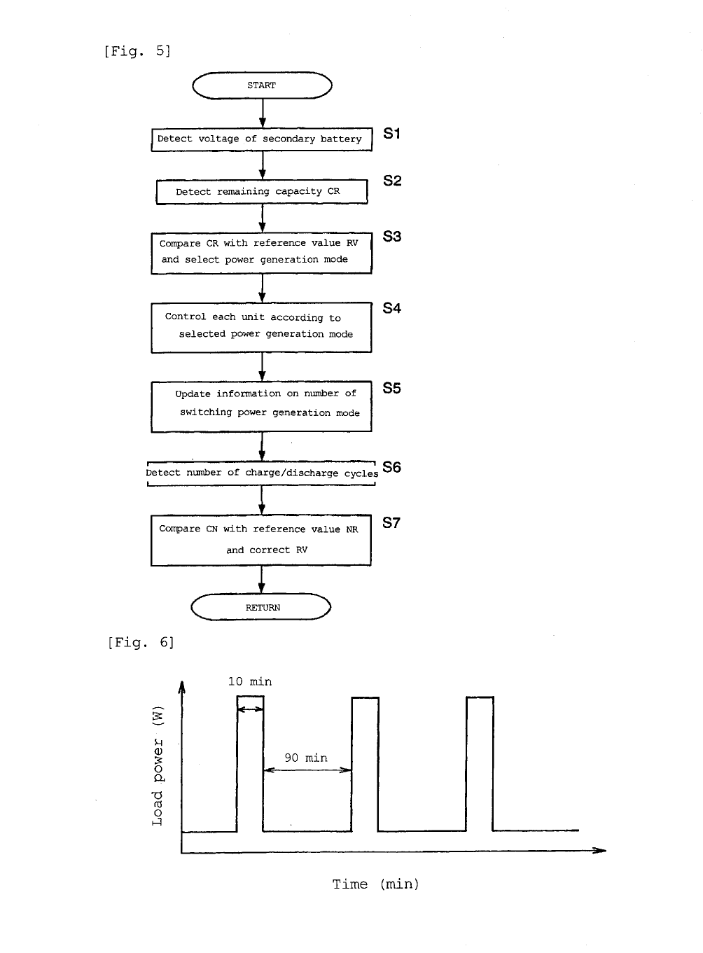

Taking as an example the case of FIG. 4B, the power generation mode setting processing of Embodiment 1 is described below with reference to the flowchart shown in FIG. 5.

When the fuel cell system 1 is activated, and the power supply to the load is started (START), the voltage of the secondary battery 8 is detected by the voltage sensor 11 (S1). On the basis of the detected value of the voltage, a computation for detecting a remaining capacity CR is performed by the arithmetic unit 7a (S2, means for detecting a remaining capacity CR). As this time, the arithmetic unit 7a refers the information stored in the memory unit 7b regarding a relationship between the voltage and remaining capacity CR of the secondary battery 8, and detects a remaining capacity CR.

The voltage of the secondary battery 8 can be detected at predetermined time intervals (e.g., every 0.5 seconds). A computation for detecting a remaining capacity CR may be performed every time the voltage is detected, or every after the voltage is detected a plurality of times. In order to level the fluctuations in battery voltage and the measurement deviation, the voltages detected a plurality of times may be averaged, and on the basis of the average, the remaining capacity CR may be determined. Alternatively, an average voltage may be calculated by moving average processing at the same intervals as the voltage is detected, and on the basis of the average, the remaining capacity CR may be determined.

Next, the arithmetic unit 7a performs a computation for comparing the detected remaining capacity CR with at least one reference value RV having been set in advance, and on the basis of the result of comparison, one power generation mode is selected from two or more power generation modes (S3, means of changing the output power stepwise). During the time immediately after activation, the arithmetic unit 7a reads the corrected reference value RV which was stored in the memory unit 7b when the operation of the fuel cell system 1 was previously deactivated, and compares the remaining capacity CR with the read corrected reference value RV, to select a power generation mode.

The controller 7 controls the fuel pump 2, the air pump 3, the DC/DC converter 9, etc., so that the fuel cell 10 can operate in the selected power generation mode (S4). The arithmetic unit 7a performs a computation for judging whether the power generation mode was switched or not, and on the basis of the result of judgment, updates the information on the number of times the power generation mode has been switched (information on the number of times of switching) stored in the memory unit 7b (S5).

Next, the arithmetic unit 7a detects or estimates the number CN of charge/discharge cycles of the secondary battery 8 on the basis of the information on the number of times of switching, by the number of charge/discharge cycles estimation processing as described in detail later (S6). The detected number CN of charge/discharge cycles is then compared with at least one reference value NR of the number of charge/discharge cycles (in FIG. 4B, NR₁, NR₂, NR₃ and NR₄) which have been set in advance, to perform a computation for correcting the reference value RV (S7), and then, the process returns to S1. In the following, the reference value correction processing for correcting the reference value RV is described.

In the secondary battery 8 in an early stage having undergone a small number of charge/discharge cycles, the higher the reference value RV of the remaining capacity CR for switching the power generation mode is, the higher the convenience for the user is. Specifically, in the aforementioned example, by setting the boundary between “low power mode” and “stop mode” to be close to 100% SOC, and setting the boundary between “low power mode” and “medium power mode” and the boundary between “medium power mode” and “high power mode” to be respectively at a comparatively high level of SOC, the secondary battery can be used constantly in a nearly fully charged state.

As a result, the capacity of the secondary battery can be utilized to a maximum extent. Thus, it is unlikely to happen that the secondary battery 8 is discharged to a range near a fully discharged state, causing a shortage of power supply to the load device. Moreover, even if the secondary battery 8 is discharged to such a range, since the range of the remaining capacity CR within which the fuel cell 8 operates in “high power mode” is widely set, the secondary battery 8 can be charged rapidly. Therefore, the capacity of the secondary battery can be restored in a shorter period of time. Accordingly, a load which consumes a large amount of power may be connected and used in a short period of time.

However, in general, the deterioration of a secondary battery is accelerated as the charge current is raised. If the fuel cell is allowed to operate in “high power mode” to rapidly charge the secondary battery, the deterioration of the secondary battery is accelerated. Moreover, if the secondary battery is rapidly charged while it is already in a deteriorated state, the speed of deterioration significantly increases. Therefore, charging the secondary battery having deteriorated to some extent with a high current is not preferable for prolonging the life of the secondary battery. In order to slow the deterioration of the secondary battery having deteriorated to some extent, it is effective to set comparatively low the reference value RV of the remaining capacity CR for switching to “high power mode”.

For the above reason, in this reference value correction processing, as shown in FIG. 4B, the reference value for switching to “high power mode” in which the secondary battery is operated with a maximum output (reference value RV₃) is set high while the number CN of charge/discharge cycles is small. On the other hand, the reference value RV₃ is corrected such that it is set lower as the number CN of charge/discharge cycles increases. By doing this, the cycle degradation of the secondary battery can be suppressed, and the life of the secondary battery can be prolonged.

Although the reference value RV₃ is set lower in four steps in FIG. 4B, this is a mere example. The reference value RV₃ may be corrected only once, or corrected in more detail.

Furthermore, in the example of FIG. 4B, the reference values (RV₁ and RV₂) other than the reference value RV₃ are also corrected such that the value is set lower stepwise as the number CN of charge/discharge cycles increases. This is because, in general, a secondary battery deteriorates very fast when overcharged. Particularly in a battery pack, the degree of deterioration varies among the individual secondary batteries due to the variations in performance among the individual secondary batteries and the temperature distribution in the battery pack. In such a case, the more the battery has deteriorated, the higher its internal resistance is, and the more this battery tends to be overcharged. As such, the more the battery has deteriorated, the more its deterioration is accelerated.

In order to avoid such drawbacks, it is effective to decrease the charge level of the battery pack as a whole, for suppressing the deterioration of the individual secondary batteries. Therefore, like the reference value for switching to “high power mode” (reference value RV₃), the reference value for switching to “medium power mode” or “low power mode” (RV₁ and RV₂) are also corrected such that it is set lower stepwise as the number CN of charge/discharge cycles increases, so that the degree of deterioration can be prevented from varying greatly among the individual secondary batteries.

It is to be noted that hysteresis can be set for the reference value RV. For example, the reference value to be referred to when switching from a power generation mode for a low output power to a power generation mode for a high output power (hereinafter, a “reference value for upward switching”) is set higher by a predetermined value a than the original reference value RV. Conversely, the reference value to be referred to when switching the power generation mode from a mode for a high output power to a mode for a low output power (hereinafter, a “reference value for downward switching”) is set lower by a predetermined value α than the original reference value RV. By setting such hysteresis for the reference value RV, it is possible to prevent the occurrence of hunting, i.e. a phenomenon in which the remaining capacity CR oscillates up and down across the reference value RV.

If hunting occurs, the power generation mode may be switched very frequently, and the power generation efficiency may decrease significantly. By setting hysteresis for the reference value RV, the occurrence of hunting can be prevented, and the power generation efficiency can be readily improved. At this time, by setting the reference value for downward switching to be 1 to 10% lower than the reference value for upward switching, the occurrence of hunting can be effectively prevented.

Next, the method of detecting the number of charge/discharge cycles is more specifically described. In the case where the fuel cell system 1 including the secondary battery 8 in a nearly fully charged state is connected to a load device, the power generation mode of the fuel cell 10 is set “stop mode” or “low power mode”, in the examples of FIGS. 4A and 4B. In this state, the consumption power of the load device generally exceeds the output of the fuel cell 10, and therefore, the secondary battery 8 is discharged, to reduce the remaining capacity CR. In the examples of FIGS. 4A and 4B (in an early stage of the operation of the system), the power generation mode of the fuel cell 10 is switched to “medium power mode” when the capacity CR is reduced to be 70% or less. The arithmetic unit 7a commands the memory unit 7b to store this switching.

If, even in this state, the consumption power of the load device still exceeds the output power of the fuel cell, the remaining capacity CR is further reduced. As a result, in the examples of FIGS. 4A and 4B (in the early stage), the power generation mode of the fuel cell is switched to “high power mode” when the remaining capacity CR is reduced to be 30% or less. The arithmetic unit 7a commands the memory unit 7b to store this switching.

When the power generation mode of the fuel cell 10 is switched stepwise from “stop mode” or “low power mode” to “high power mode”, the arithmetic unit 7a judges the secondary battery as having discharged once. If the consumption power of the load device is reduced during operation in “high power mode” to fall below the output of the fuel cell, the secondary battery is charged, to increase the remaining capacity CR. When the remaining capacity CR is increased to be 30% or more, the power generation mode is switched to “medium power mode”, and as the charging proceeds, switched to “low power mode” or “stop mode”. The arithmetic unit 7a commands the memory unit 7b to store the information on these switching. On the basis of the stored information, the arithmetic unit 7a senses that the secondary battery 8 has charged once. From the combination of one discharge detected above and one charge detected here, the number of charge/discharge cycles of the secondary battery is judged as having increased by “1”.

Other than the counting method of the number of charge/discharge cycles as described above, the following simplified counting method is possible. For example, the number of times the secondary battery has been discharged is counted as “1” when the power generation mode of the fuel cell 10 is switched from “medium power mode” to “high power mode”. On the other hand, the number of times the secondary battery has been charged is counted as “1” when the power generation mode of the fuel cell 10 is switched from “low power mode” to “stop mode”. The number of charge/discharge cycles can be counted simply by counting the combination of these as “1 cycle”.

In contrast to the simplified method as described above, the number of charge/discharge cycles can be measured so as to more accurately reflect the deterioration of the secondary battery. For example, when the power generation mode is switched from “low power mode” to “medium power mode” and then switched back to “low power mode” without being switched to “high power mode”, the number is counted as “½ cycle”, and when a similar switching of the power generation mode occurs again, the number is counted as “1 cycle” by totaling these count numbers. Alternatively, when the power generation mode is switched sequentially in the order of “low power mode”, “medium power mode” and “low power mode”, the number is counted as “½ cycle”, and when the power generation mode is switched sequentially in the order of “medium power mode”, “high power mode” and “medium power mode”, the number is also counted as “½ cycle”, and these count numbers are totaled as “1 cycle”.

By allowing the number of cycles to be set in detail according to various switching patterns of the power generation mode as describe above, rather than counting only a charge/discharge operation in which the secondary battery is discharged from a fully charged state to a fully discharged state and then charged again to a fully charge state as “one cycle”, the number CN of charge/discharge cycles can more accurately reflect the deterioration of the secondary battery. As a result, the reference value RV can be corrected more appropriately on the basis of the number CN of charge/discharge cycles.

Next, a method of controlling a fuel cell system according to Embodiment 2 of the present invention is described.

### Embodiment 2

The basic configuration of the fuel cell system of Embodiment 2 is similar to that of the fuel cell system 1 of Embodiment 1. In the following, the differences from Embodiment 1 are described.

In Embodiment 2, the arithmetic unit 7a compares the number CN of charge/discharge cycles and a reference value NR_{f} (not shown), and when the number CN of charge/discharge cycles is equal to or more than the reference value NR_{f}, executes a processing (alarm processing) for displaying a message to notify the user that the life of the secondary battery is approaching its end. At this time, the reference value correction processing may be performed, similarly to in Embodiment 1, or may not be performed. The alarm processing is specifically described below.

The reference value NR_{f} regarding the timing of notifying the life of the secondary battery can be set on the basis of a timing when the quantity of electricity that can be derived from the secondary battery in a fully charged state is reduced to a quantity of electricity required for reactivating the fuel cell system 1, plus a margin. In general, the reference value NR_{f} of the number CN of charge/discharge cycles is preferably set to be equal to the number of cycles counted when the quantity of electricity that can be derived from the secondary battery in a fully charged state is reduced to 20 to 50% of that of the unused secondary battery in the early stage.

The notification of the life can be executed by displaying on the fuel cell system or the user interface of the load device. For example, upon reception of an alarm signal, the user interface notifies the user that the life of the secondary battery of the fuel cell system is approaching its end. In the case where the secondary battery is incorporated in the fuel cell system, the user can ask a maintenance service provider or the like to replace the secondary battery; and in the case where the secondary battery is mounted on the device used, the user him/herself can replace the secondary battery.

Alternatively, in order to further increase the convenience, it is preferable to notify the user earlier than when the life of the secondary battery reaches a cycle life determined on the above basis. For example, it is preferable to notify the user that the life is about to end when the number of charge/discharge cycles exceeds 80% of the cycle life. Alternatively, in a system in which the coefficient of correlation between the operation time of the fuel cell 1 and the number CN of charge/discharge cycles is high, a relational formula between the operation time of the fuel cell 1 and the number CN of charge/discharge cycles is determined in advance, and stored in the memory unit 7b. The arithmetic unit 7a can thus highly accurately determine the number CN of charge/discharge cycles from the operation time of the fuel cell system 1.

In such a case, a total operation time of the fuel cell system 1 until the secondary battery 8 reaches the end of its cycle life can be determined, and furthermore, from the operation time of the fuel cell system 1 at that point of time, the remaining life of the secondary battery 8 can be determined accurately, and notified to the user.

Next, Examples of the present invention are described. These examples, however, should not be construed as limitations on the scope of the present invention.

### Example 1

An anode catalyst supporting material including a particulate anode catalyst and a conductive carrier supporting the particulate anode catalyst was prepared. Here, platinum-ruthenium alloy (atomic ratio 1:1) (average particle size: 5 nm) was used as the particulate anode catalyst. Conductive carbon particles having an average primary particle size of 30 nm were used as the carrier. The weight ratio of the platinum-ruthenium alloy to the total of the platinum-ruthenium alloy and conductive carbon particles was 80 wt %.

A cathode catalyst supporting material including a particulate cathode catalyst and a conductive carrier supporting the particulate cathode catalyst was prepared. Here, platinum (average particle size: 3 nm) was used as the particulate cathode catalyst. Conductive carbon particles having an average primary particle size of 30 nm were used as the carrier. The weight ratio of the platinum to the total of the platinum and conductive carbon particles was 80 wt %.

The polymer electrolyte membrane used here was a fluoropolymer film (film mainly composed of perfluorosulfonic acid/polytetrafluoroethylene copolymer (H⁺ type), trade name “Nafion® 112”, available from E. I. du Pont de Nemours and Company) having a thickness of 50 μm.

(a) Production of CCM

(a-1) Preparation of Anode

First, 10 g of the anode catalyst supporting material and 70 g of a dispersion containing perfluorosulfonic acid/polytetrafluoroethylene copolymer type) (trade name: “5 wt % Nafion® solution”, available from E. I. du Pont de Nemours and Company) were mixed with an appropriate amount of water in a stirrer. The resultant mixture was defoamed, to give an ink for forming an anode catalyst layer.

The ink for forming an anode catalyst layer was applied onto one surface of the polymer electrolyte membrane by spraying it thereto with an air brush, to form a square anode catalyst layer of 10 cm on each side. The size of the anode catalyst layer was adjusted by masking. In spraying the ink for forming an anode catalyst layer, the polymer electrolyte membrane was adsorbed under reduced pressure to be fixed onto a metal plate whose surface temperature was adjusted with a heater, so that the ink for forming an anode catalyst layer was gradually dried as it was applied. The thickness of the anode catalyst layer was 61 μm. The amount of Pt—Ru per unit area was 3 mg/cm².

(a-2) Preparation of Cathode

First, 10 g of the cathode catalyst supporting material and 100 g of a dispersion containing perfluorosulfonic acid/polytetrafluoroethylene copolymer (H⁺ type) (the aforementioned trade name: “5 wt % Nafion® solution”) were mixed with an appropriate amount of water in a stirrer. The resultant mixture was defoamed, to give an ink for forming a cathode catalyst layer.

The ink for forming a cathode catalyst layer was applied in the same manner as in forming an anode catalyst layer, onto the other surface of the polymer electrolyte membrane opposite to the surface with the anode catalyst layer formed thereon. A square cathode catalyst layer of 10 cm on each side was thus formed. The amount of Pt contained in the cathode catalyst layer per unit area was 1 mg/cm². The anode and cathode catalyst layers were positioned such that the centers of these layers were overlapped each other in the thickness direction of the polymer electrolyte membrane.

The CCM was thus produced.

(b) Production of MEA

(b-1) Preparation of Anode Porous Substrate

A carbon paper (trade name: “TGP-H-090”, thickness: approx. 300 μm, available from Toray Industries Inc.) having been subjected to water-repellent treatment was immersed for 1 minute in a diluted polytetrafluoroethylene (PTFE) dispersion (trade name: “D-1”, available from Daikin Industries, Ltd.). Thereafter, the carbon paper was dried in a hot air dryer at 100° C. The carbon paper after drying was then baked in an electric furnace at 270° C. for 2 hours. In such a manner, an anode porous substrate having a PTFE content of 10 wt % was prepared.

(b-2) Preparation of Cathode Porous Substrate

A cathode porous substrate having a PTFE content of 10 wt % was prepared in the same manner as in preparing an anode porous substrate, except that a carbon cloth (trade name: “AvCarb® 1071HCB”, available from Ballard Material Products, Inc.) was used in place of the carbon paper having been subjected to water-repellent treatment.

(b-3) Formation of Anode Water-Repellent Layer

Acetylene black powder and a PTFE dispersion (trade name: “D-1”, available from Daikin Industries, Ltd.) were mixed in a stirred, to give an ink for forming a water-repellent layer in which the content of PTFE in the total solids was 10 wt % and the content of acetylene black in the total solids was 90 wt %. The ink for forming a water-repellent layer was applied onto one surface of the anode porous substrate, by spraying it thereto with an air brush. The ink thus applied was then dried in a constant temperature oven at 100° C. Subsequently, the anode porous substrate with the ink for forming a water-repellent layer applied thereon was baked in an electric furnace at 270° C. for 2 hours to remove the surfactant. In such a manner, an anode water-repellent layer was formed on the anode porous substrate, and an anode diffusion layer including the anode porous substrate and the anode water-repellent layer was prepared.

(b-4) Formation of Cathode Water-Repellent Layer

A cathode water-repellent layer was formed on one surface of the cathode porous substrate in the same manner as in forming an anode water-repellent layer. A cathode diffusion layer including the cathode porous substrate and the cathode water-repellent layer was thus prepared.

The anode and cathode diffusion layers were each cut out into a square of 10 cm on each side, using a cutting die.

Next, the anode diffusion layer was placed on the CCM such that the anode water-repellent layer was brought into contact with the anode catalyst layer. Likewise, the cathode diffusion layer was placed on the CCM such that the cathode water-repellent layer was brought into contact with the cathode catalyst layer.

The resultant layered body was pressed for 1 minute with a pressure of 5 MPa in a heat pressing machine with a temperature setting of 125° C. Thus, the anode catalyst layer was bonded to the anode diffusion layer, and the cathode catalyst layer was bonded to the cathode diffusion layer.

In the manner as described above, a membrane-electrode assembly (MEA) comprising the anode, the polymer electrolyte membrane, and the cathode was produced.

(c) Placement of Gasket

A 0.25-mm-thick ethylene propylene diene (EPDM) rubber sheet was cut into a square of 12 cm on each side. Further, the center portion of the sheet was cut out to have a square opening of 10 cm on each side. Two gaskets were prepared in this manner. The gaskets were placed on the MEA such that the anode fitted into the opening of one gasket, and the cathode fitted into the opening of the other gasket.

(d) Production of Separator

A 12-cm-square resin-impregnated graphite plate having a thickness of 2 mm was prepared as a material for a separator. One surface of the graphite plate was grooved, thereby to form a fuel flow channel for supplying an aqueous methanol solution to the anode. An inlet of the fuel flow channel was provided on one end of the separator, and an outlet of the fuel flow channel was provided on the other end thereof.

On the other surface of the graphite plate, an air flow channel for supplying air as an oxidant to the cathode was formed. An inlet of the air flow channel was provided on one end of the separator, and an outlet of the air flow channel was provided on the other end thereof. In the manner as described above, a separator for the fuel cell stack 1 was produced.

The cross-sectional shape of the groove constituting the fuel flow channel and the air flow channel was 1 mm in width and 0.5 mm in depth. The fuel flow channel and the air flow channel were both shaped in a serpentine shape which allows fuel and air to be evenly and uniformly supplied throughout the anode diffusion layer and the cathode diffusion layer.

(e) Production of DMFC Cell Stack

A cell stack comprising 20 cells was formed by laminating the MEAs and separators such that the fuel flow channel of the separator faced the anode diffusion layer, and the air flow channel faced the cathode diffusion layer. Here, for a pair of the separators disposed at the outermost ends, separators having a fuel flow channel or an air flow channel only on one surface were used.

The 20-cell stack thus formed was sandwiched between a pair of end plates each made of a 1-cm-thick stainless steel plate, in the stacking direction. Between the end plate and the separator at the outermost end, a current collector plate made of a 2-mm-thick gold-plated copper plate and an insulating plate were disposed. The current collector plate was disposed on the separator side, and the insulating plate was disposed on the end plate side. In this state, the end plates were clamped to each other with bolts, nuts, and springs, to apply pressure to the MEAs and separators.

In the manner as described above, a DMFC cell stack having a size of 12×12 cm was produced.

(f) Configuration of Fuel Cell System

The DMFC cell stack (hereinafter referred to as the “fuel cell”) was used to configure a fuel cell system. Care was taken to precisely adjust the amounts of air and fuel supplied to the fuel cell, to increase the accuracy of experiment. In supplying air, instead of supplying via a general air pump, compressed air from a high pressure air tank was supplied to the fuel cell, with the flow rate thereof being adjusted with a massflow controller available from Horiba, Ltd. In supplying fuel, a high precision pump (trade name: Personal pump NP-KX-100) available from Nihon Seimitsu Kagaku Co., Ltd. was used.

The cooling unit used here was a blower (model No.: 412JHH) available from ebm-papst Inc. USA.

The precision pump serving as the fuel supply unit, the mass flow controller serving as the air supply unit, the blower serving as the cooling unit were connected to a personal computer serving as the controller, so that the controller can control the activation and stop of each unit and the flow rate adjustment.

The liquid collector used here was a rectangular polypropylene container having a square base of 5 cm on each side and a height of 10 cm. On top of the liquid collector, porous TEMISH® (gas-liquid separation membrane) available from Nitto Denko Corporation was bonded by thermal welding.

The inlets of the fuel flow channels of the unit cells of the fuel cell were connected to the fuel pump with silicon tubes and a manifold. Likewise, the outlets of the fuel flow channels of the unit cells was connected to the liquid controller with silicon tubes and a manifold. The inlets and outlets of the air flow channels of the unit cells were connected to the mass flow controller and to the liquid collector, respectively, with silicon tubes and a manifold.

The fuel cell was placed inside a rectangular casing made of plastic. The inner surfaces of the top and bottom of the casing were brought into contact with the top surface and bottom surface of the fuel cell (one and the other end surfaces of the fuel cell in the stacking direction), so that air from the blower will not pass therebetween. On the other hand, the inner surfaces of both sides of the casing were spaced apart from both side surfaces of the fuel cell by 10 mm each, so that the air from the blower can pass therethrough. The blower was installed so as to blow air toward the opening portion of the casing.

The secondary battery used here was a battery pack comprising seven lithium ion batteries CGR26650 (electric capacity: 3.1 Ah) connected directly. The battery pack was equipped with a voltage sensor which acts as the means for detecting a remaining capacity, so that information on voltage can be sent to the personal computer serving as the controller. Information showing a relationship between the voltage and the remaining capacity of the battery pack had been obtained by survey in advance and was inputted in the personal computer, so that the personal computer serving as the controller (arithmetic unit 7a) can detect a remaining capacity on the basis of the voltage of the battery pack. The remaining capacity was measured every 0.5 seconds, and the change rate of the remaining capacity was determined as an average of the measured values for 10 seconds. On the basis of the average remaining capacity thus obtained, the control mode and power generation mode were selected.

The fuel cell was connected to the battery pack via a DC-DC converter. The DC-DC converter was connected to the personal computer serving as the controller, so that the input voltage of the DC-DC converter, i.e. the output voltage of the fuel cell, can be adjusted from the personal computer.

(g) Setting of Power Generation Mode and Control Mode of Fuel Cell

(g-1) Power Generation Mode

The following three modes were set as the power generation mode of the fuel cell.

High power mode: output voltage 8 V

Medium power mode: output voltage 9 V

Low power mode: output voltage 11 V

Specifically, the personal computer serving as the controller was set to send a signal to the DC-DC converter, thereby to control the DC-DC converter such that the voltage of the fuel cell became equal to the above set value. The DC-DC converter was equipped with a current sensor (not shown) so that the output current of the fuel cell during power generation can be measured and transmitted to the personal computer serving as the controller.

Shown below is a net output of the fuel cell in an early stage of power generation in each power generation mode (30 minutes after the start of power generation), i.e. an output value obtained by subtracting the power consumed by the fuel supply unit, air supply unit, and cooling unit, from the output of the fuel cell stack.

High power mode: 100 W

Medium power mode: 60 W

Low power mode: 30 W

The personal computer serving as the controller was set to determine amounts of fuel and air supplied, by multiplying the value measured by the current sensor (the output current) by the preset stoichiometric ratio, and to control the precision pump and massflow controller on the basis of the determined amounts of fuel and air supplied. The fuel stoichiometric ratio was set to 1.5, and the air stoichiometric ratio was set to 2.

The output terminal of the fuel cell system was connected to an electron load device “PLZ164WA” (available from Kikusui Electronics Corp.), instead of connecting to an actual electric device, and the fuel cell system was operated, while the output was varied as appropriate.

(g-2) Reference Value RV and Control Mode

Hysteresis was set for the reference value RV for switching the power generation mode, in order to prevent the occurrence of hunting. Specifically, the reference value referred to when changing the power generation mode in the direction to increase the output from the present mode (the reference value for downward switching) was constantly set to be 2% lower than the reference value for switching in the reverse direction (the reference value for upward switching). Here, the median of the reference value for upward switching and the median of the reference value for downward switching are each termed to as the “median of reference value”.

Each reference value was changed in four steps as follows, depending on the number of charge/discharge cycles.

(A) When the number of charge/discharge cycles is less than 200 cycles

Median of reference value between low and medium power modes: 88%

Median of reference value between medium and high power modes: 60%

(B) When the number of charge/discharge cycles is equal to or more than 200 cycles and less than 400 cycles

Median of reference value between low and medium power modes: 86%

Median of reference value between medium and high power modes: 55%

(C) When the number of charge/discharge cycles is equal to or more than 400 cycles and less than 600 cycles

Median of reference value between low and medium power modes: 84%

Median of reference value between medium and high power modes: 50%

(D) When the number of charge/discharge cycles is equal to or more than 600 cycles and less than 800 cycles

Median of reference value between low and medium power modes: 82%

Median of reference value between medium and high power modes: 40%

(E) When the number of charge/discharge cycles is equal to or more than 800 cycles and less than 1000 cycles

Median of reference value between low and medium power modes: 80%

Median of reference value between medium and high power modes: 30%

As for the counting of the number of charge/discharge cycles, a method that can be done at minimum cost for the system was selected. Specifically, in this Example, only the number of times the mode has been switched from medium to high power mode and the number of times the mode has been switched from medium to low power mode were stored, and a pair of these numbers was counted as “one cycle”. These computations were performed by the personal computer serving as the controller.

The charge/discharge cycle life of the secondary battery and the timing of notifying the user thereof were set as follows.

First, the quantity of electricity required for activating the fuel cell system was measured, and it was 1 Wh. On the other hand, the electric capacity of the secondary battery was about 78 Wh, which is still sufficient for activation. Basic data shows that the remaining capacity reaches 80% when the number of charge/discharge cycles performed at 25° C. reaches 1000 cycles. On the basis of the basic data, the timing of notification to the user was set at when the number of cycles reaches 800 cycles, with a safety margin included. Specifically, software in the personal computer serving as the controller in this Example was used to set the personal computer, i.e. the user interface, to display a message that reads “Replacement of secondary battery is recommended”.

### Example 2

The notification of the life of the secondary battery was performed in the same manner as in Example 1, except that the median of reference vale regarding the remaining capacity CR was set constant as shown below, regardless of the number of charge/discharge cycles.

Median of reference value between low and medium power modes: 80%

Median of reference value between medium and high power modes: 50%

### Comparative Example 1

The fuel cell was operated always in “high power mode”, except that the operation of the fuel cell was stopped when the remaining capacity CR reached 100% in terms of SOC. The number of charge/discharge cycles was detected only when the mode was switched between “high power mode” and “stop mode”. The notification of the life of the secondary battery was performed in the same manner as in Example 1, except the above.

### EVALUATION

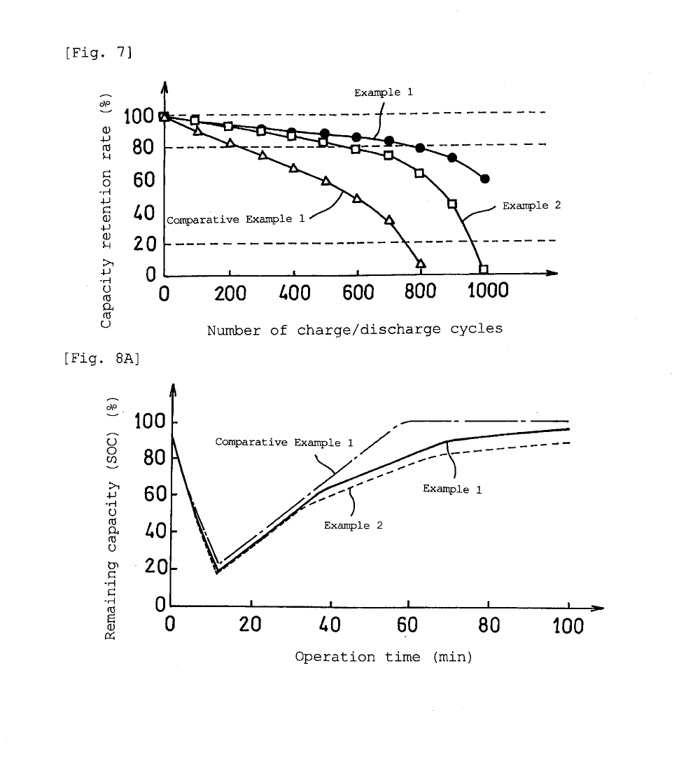

In order to more clearly show the effects of the present invention by increasing the charge/discharge frequency of the secondary battery included in the fuel cell system, the fuel cell system was operated continuously in a load power profile as shown in FIG. 6. Specifically, the fuel cell system was operated continuously in a load power profile in which a heavy load state for 10 minutes at a load power of 350 W and a light load state for 90 minutes at a load power of 20 W were alternately repeated. As for the environmental condition, the fuel cell system was placed in a 45° C. constant temperature bath so that the cycle deterioration of the secondary battery was easily accelerated.

With respect to the secondary battery included in each of the fuel cell systems of Examples 1 and 2 and Comparative Example 1, the changes in the charge/discharge capacity of the secondary battery are shown in FIG. 7 as a graph, in relation to the number of charge/discharge cycles. The vertical axis of the graph represents a capacity retention rate, with the charge/discharge capacity of the secondary battery in an early stage taken as 100%. The changes in the charge/discharge capacity were checked by removing the secondary battery from the fuel cell system every time when the number of charge/discharge cycles increased by 100 cycles, and measuring the charge/discharge capacity of the battery under the same conditions.

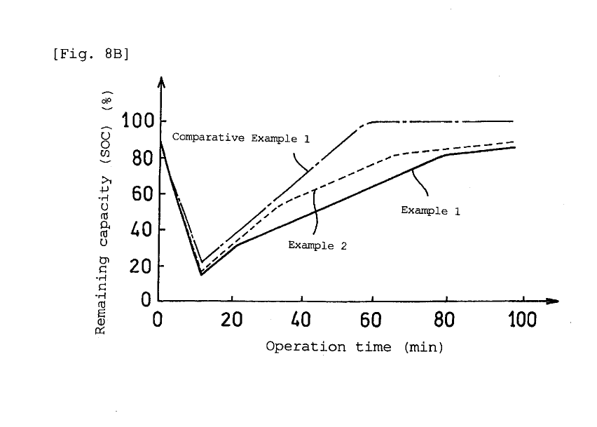

The changes in the remaining capacity CR at the 1^{st} cycle of each fuel cell system are shown in FIG. 8A. The changes in the remaining capacity CR at the 801^{th} cycle of each fuel cell system are shown in FIG. 8B.

Although not shown, charge and discharge of the secondary battery was performed using a charge/discharge device such that the remaining capacity changed similarly to that in Example 2 of FIG. 8A. Although not shown, the changes in remaining capacity in Example 2 of FIG. 7 coincided with those of a single secondary battery when subjected to charge/discharge cycles under the same conditions. This verified that, in each Example, the number of charge/discharge cycles accurately reflects the deterioration of the secondary battery.

As clear from FIG. 7, in Examples 1 and 2, the charge/discharge cycle life (the number of cycles until the capacity reaches 80% of the initial capacity) was increased as compared with in Comparative Example 1. This verified that the life of the secondary battery can be prolonged by switching the power generation mode of the fuel cell, depending on the remaining capacity CR.

Comparison of Examples 1 and 2 with Comparative Example 1 in FIG. 8A would well explain the factors behind this. It is presumable that among the graphs in the figure, the higher the rate of changes in the remaining capacity was, the higher the current discharged from or charged to the secondary battery would have been. Observation of the changes in capacity during charging shows that in Comparative Example 1, since the output power of the fuel cell was constant, the secondary battery was kept charged with a comparatively high current from when the remaining capacity was within a low range to when it reached a high range, and moreover, after full charge was reached, the high remaining capacity was maintained. On the other hand, in Examples 1 and 2, the secondary battery was charged with a high current upon start of charging, but with increase in the remaining capacity CR due to switching of the power generation mode, the charge current reduced. Moreover, since the charge current in “low power mode” was very low, the discharge of the next cycle was started before the remaining capacity reached 100%. Presumably for the reasons above, the secondary batteries in Examples 1 and 2 had a longer life that that in Comparative Example 1.

Comparison between Example 1 and Example 2 shows that the charge/discharge cycle in Example 1 was prolonged. In this regard, as shown in FIG. 8B, in Example 1, the charging time with low current increased as the number of charge/discharge cycles increased. Presumably because of this, the deterioration of the secondary battery was suppressed.

In Examples 1 and 2, a message that reads “Replacement of secondary battery is recommended” appeared on the display of the personal computer at a point of time when the number of charge/discharge cycles exceeded 800 cycles. This verified that it is possible to notify the user that the life of the secondary battery is approaching its end.

Here, in each Example, in order to speedily evaluate the charge/discharge cycles, the operation time under a light load was set short. However, if in actual use, the operation time under a light load is increased, the charging time in FIGS. 8A and 8B would be prolonged, to proceed the charging of the secondary battery until the remaining capacity reaches a high range, and eventually, the fuel cell would be turned into stop mode.

In Example 1, even under such conditions in actual use, the remaining capacity of the secondary battery for switching to stop mode was set smaller as the number of charge/discharge cycles increases. By doing this, even if the capacity varies among the cells of the battery pack due to cycle deterioration, the deterioration of the secondary battery can be suppressed without causing overcharge.

As described above, according to the present invention, while the charge current and the remaining capacity in a fully charged state of the secondary battery are properly controlled, the number of charge/discharge cycles can be accurately detected. This makes it possible to notify the user a timing of replacing the secondary battery, and to prolong the life of the fuel cell system.

In the above embodiments, description was given of the case of applying to a DMFC using methanol as a fuel; however, the fuel cell is not limited to a DMFC. The present invention is most effective when applied to a direct oxidation fuel cell using a fuel which is liquid at room temperature and has good affinity with water. Other than methanol, examples of the fuel being liquid at room temperature include a hydrocarbon-based liquid fuel such as ethanol, dimethyl ether, formic acid, and ethyleneglycol.

According to the present invention, even in the case where the minimum necessary output of the fuel cell and the minimum necessary capacity of the secondary battery capacity are selected for achieving a small-size and light-weight system, the system can be applied to various devices differing in consumption power. By notifying the user of the deterioration state of the secondary battery, the convenience and reliability of the system can be improved. Furthermore, by suppressing the deterioration of the secondary battery, a fuel cell system having a long life can be provided.

### INDUSTRIAL APPLICABILITY

The fuel cell system and the method for controlling the same of the present invention are useful when applied, for example, as a power source of portable small-size electronic equipment such as notebook personal computers, cellular phones, and personal digital assistants (PDAs), or as a portable power source for outdoor activities such as camping. The fuel cell system and the method for controlling the same of the present invention are further applicable as a power source for electric motor scooters.

### REFERENCE SIGNS LIST

1 Fuel cell system
2 Fuel pump
3 Air pump
4 Fuel tank
7 Controller
7a Arithmetic unit
7b Memory unit
8 Secondary battery
10 Fuel cell
11 Voltage sensor
12 Current sensor

1. A method for controlling a fuel cell system including a fuel cell and a secondary battery, to variably control an output power of the fuel cell, the method comprising the steps of:
(i) charging the secondary battery with the output power or discharging the secondary battery, depending on an amount of power supplied to a load and the output power;
(ii) detecting a remaining capacity CR of the secondary battery;
(iii) selecting one of two or more preset power generation modes of the fuel cell differing in the output power, depending on the remaining capacity CR;
(iv) detecting the number of cycles of the charging and discharging of the secondary battery; and
(v) correcting conditions for selecting the power generation mode, on the basis of the detected number of cycles of the charging and discharging.

2. The method for controlling a fuel cell system according to claim 1, wherein the number of cycle of the charging and discharging is detected, on the basis of the number of times the power generation mode has been switched.

3. The method for controlling a fuel cell system according to claim 1, wherein:
the step (iii) includes
comparing the remaining capacity CR with at least one reference value RV, and
selecting the power generation mode, on the basis of a result of the comparison; and
the step (v) includes
correcting the at least one reference value RV, on the basis of the detected number of cycles of the charging and discharging.

4. The method for controlling a fuel cell system according to claim 3, wherein a power generation mode for a higher output power is selected from the two or more power generation modes, as the remaining capacity CR decreases.

5. The method for controlling a fuel cell system according to claim 3, wherein:
the at least one reference value RV includes two or more different reference values RV₁, RV₂, . . . , RVₙ, where RV₁>RV₂> . . . >RVₙ; and
the number of cycles of charging and discharging is detected on the basis of the number of times the remaining capacity CR has decreased from a value equal to or more than the reference value RV₁ to a value less than the reference value RV₁, and the number of times the remaining capacity CR has increased from a value less than the reference value RVₙ to a value equal to or more than the reference value RVₙ.

6. The method for controlling a fuel cell system according to claim 1, wherein the remaining capacity CR is detected on the basis of a voltage of the secondary battery.

7. The method for controlling a fuel cell system according to claim 6, wherein the voltage of the secondary battery is detected on the basis of a voltage of a capacitor connected in parallel with the secondary battery.

8. A method for controlling a fuel cell system including a fuel cell and a secondary battery, to variably control an output power of the fuel cell, the method comprising the steps of:
(i) charging the secondary battery with the output power or discharging the secondary battery, depending on an amount of power supplied to a load and the output power;
(ii) detecting a remaining capacity CR of the secondary battery;
(iii) comparing the remaining capacity CR with at least one reference value RV, and selecting one of two or more preset power generation modes of the fuel cell differing in the output power, on the basis of a result of the comparison; and
(iv) detecting the number of cycles of the charging and discharging, on the basis of the number of times the power generation mode has been switched.

9. The method for controlling a fuel cell system in accordance with claim 1, further comprising the step of creating and outputting information on life of the secondary battery, on the basis of the detected number of cycles of the charging and discharging.

10. A fuel cell system including a fuel cell and a secondary battery, to variably control an output power of the fuel cell, the system comprising:
a means for charging the secondary battery with the output power or discharging the secondary battery, depending on an amount of power supplied to a load and the output power of the secondary battery;
a means for detecting a remaining capacity CR of the secondary battery;
a means for selecting one of two or more preset power generation modes of the fuel cell differing in the output power, depending on the remaining capacity CR;
a means for detecting the number of cycles of the charging and discharging the secondary battery; and
a means for correcting conditions for selecting the power generation mode, on the basis of the detected number of cycles of the charging and discharging.

11. A fuel cell system in accordance with claim 10, wherein the number of cycles of the charging and discharging is detected on the basis of the number of times the power generation mode has been switched.
